(19) United States
(12) Patent Application Publication
(10) Pub. No.: US 2016/0203266 A1
(43) Pub. Date: Jul. 14, 2016

(54) SYSTEMS AND METHODS FOR GENERATING CUSTOMIZED MEDIA FOR HUMAN RESOURCE MANAGEMENT

(71) Applicant: Mazonson and Santas LLC. dba ClearCost Health, Larkspur, CA (US)

(72) Inventors: Peter Mazonson, Menlo Park, CA (US); Syam Palakurthy, Goleta, CA (US); Jake Mazonson, Oakland, CA (US); Sonali Sheel, San Francisco, CA (US); Bob Hart, San Francisco, CA (US); Rey David, Danville, CA (US); Tagore Smith, Florence, MA (US); Patrick Seymour, Florence, MA (US); Raf Anzovin, Florence, MA (US); Will Colon, Florence, MA (US)

(21) Appl. No.: 14/594,156

(22) Filed: Jan. 11, 2015

(51) Int. Cl. G06F 19/00; G06Q 40/06; G06F 17/30

(52) U.S. Cl. CPC G06F 19/322; G06F 17/30867; G06F 17/303; G06Q 40/06

(57) ABSTRACT

Systems and methods for presenting customized media for human resource management are provided. In some embodiments, data is received for users from one or more data sources. The data sources can include an insurance company; a pharmacy benefit manager, a benefits administration and enrollment database; an Human Resources Information System (HRIS) database; a database with information on employer-sponsored accounts such as a Health Savings Account (HSA), Health Reimbursement Accounts (HRA), Flexible Spending Accounts (FSA), a database of investment allocation for employer-sponsored savings programs, or a database that uses 270/271 transactions to determine accumulated health spend. The data can be used to generate customized media specific to each user. The customization includes incorporating the acquired data specific to the user into the media. The customized media is then presented to the user using text, animation, or live-action video.

### BACKGROUND

The present invention relates to systems and methods for the generation, management and presentation of customized media, which includes animations, live-action videos, and notifications that are tailored to a specific user based on data. Media customization allows data relevant to the viewer of the media to be incorporated into a presentation for educational or marketing purposes. Since the media being provided is relevant to the user, ideas may be more accurately presented, and may be more impactful to the user than generic media presentations.

Currently, media of all types inundates us. While some media is intended to entertain, much of the media prepared has important information that the media developer is trying to impress upon the user. For example, instructional media may attempt to educate a viewer. Marketing media may attempt to make the viewer aware of a product, and influence viewer choices. The practice of generating effective media is well researched, and is a substantial industry. Any improvement in media's effectiveness may have major impact on education regarding a topic in a target population, or may cause significant shifts in user behaviors.

One means of making media more effective is to increase relevancy of the information to the target viewer. When the media is being generated for widespread distribution, media producers are often forced to rely upon generalized demographic data or information in order to make choices of what media to present, in what manner, and in what sequence.

With increases in data availability, there has been a push towards customizing information in media presentation to users. In the field of marketing, this trend has been dubbed “targeted advertising”. Indeed, using cookies or other known tracking technology, users are often provided ads for products or services that they have searched for, or that relate to their search patterns. Likewise, using knowledge of what a user likes or dislikes, media may be sorted and only media that is likely to be relevant to the user is provided.

By making media more relevant to the user, there has been a discernable impact on product sales (in the marketing context) and on the effectiveness of educational materials.

However, targeted media presentation is generally limited to selection of which media to present to the user. In a few cases, the media may be customized for the user (such as media generated in response to a request for proposal); however, these customized responses are typically either limited to minor text edits to emails or letters, or they require significant human intervention to generate tailored content. Certainly within the field of video and animation media, user customization is limited.

It is therefore apparent that a need exists for the generation and presentation of customized media in a scalable format, in particular customized video or animation content are needed. Such customized media would enable enhanced user relevance, which is very important when educating a user or when attempting to market goods or services to a user in a compelling manner.

### SUMMARY

To achieve the foregoing and in accordance with the present invention, systems and methods for presenting customized media for human resource management are provided. Such systems and methods enable employees to make more informed choices regarding benefits and other human resources decisions, including, but not limited to, selection of insurance plans, selection of other benefits, retirement savings decisions, more effective and efficient health insurance and health care utilization, and improved care.

In some embodiments, data is received for users from one or more data sources. The data sources can include an insurance company; a pharmacy benefit manager, a benefits administration and enrollment database; an Human Resources Information System (HRIS) database; a database with information on employer-sponsored accounts such as a Health Savings Account (HSA), Health Reimbursement Accounts (HRA), Flexible Spending Accounts (FSA); a database of investment allocation for employer-sponsored savings programs such as a 401(k) program; or a database that uses 270/271 transactions or other time-lagged methods to determine accumulated health spend. The data can be used to generate customized media specific to each user. The customization includes incorporating the acquired data specific to the user into the media. The customized media is then presented to the user.

In some embodiments, the customized media is one or more videos. These videos may explain particular benefit plan selections of the user, using the benefits administration and enrollment database. Likewise, the customized media may include information about alternative health plan choices offered to the user that are more appropriate for the user's care needs based upon previous plan selections and other data within the accumulated claims or health spend databases.

Likewise, the customized media may include videos that show users with specific chronic diseases information how to better manage the diseases, and how to access a second opinion services offered by the user's company. Likewise, the customized animated media may include videos that show users with high use of emergency room services information on less expensive options.

In some embodiments, the customized media may include videos that shows the user ways to save money on medications, including less expensive medication options, medication dosing, and medication fulfillment options, based upon the users current prescription information. Likewise, the customized animated media may include videos that show users with frequent treatment or diagnostic usage rates information on lower cost sources of the treatment or diagnostic services near the user's address.

Additionally, the customized media may include videos that show users how to optimize savings within a retirement vehicle in comparison to current retirement savings elections. Likewise, the customized animated media may include videos that show users information regarding pre-tax benefits for transportation assistance, child care assistance, and medical savings plans.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generating and presenting customized media, in accordance with some embodiment;

FIG. 2 is an example logical diagram of a user device, in accordance with some embodiment;

FIG. 3 is an example logical diagram of a media customization module within the user device, in accordance with some embodiment;

FIG. 4 is an example logical diagram of a customized media server, in accordance with some embodiment;

FIG. 5A is an example logical diagram of a user account manager of the customized media server, in accordance with some embodiment;

FIG. 5B is an example logical diagram of a media selection controller of the customized media server, in accordance with some embodiment;

FIG. 6 is an example logical diagram of a processing server, in accordance with some embodiment;

FIG. 7 is an example flow diagram for the presentation of customized media, in accordance with some embodiment;

FIG. 8 is an example flow diagram for the process of determining which media to be presented, in accordance with some embodiment;

FIG. 9 is an example flow diagram for the process of optimizing content to a user, in accordance with some embodiment;

FIG. 10 is an example flow diagram for the process of determining if the media is to be pre-rendered, in accordance with some embodiment;

FIG. 11 is an example flow diagram for the process of pre-rendering media, in accordance with some embodiment;

FIG. 12 is an example flow diagram for the process of on-the-fly media rendering, in accordance with some embodiment;

FIG. 13 is an example flow diagram for the process of populating user account with the media content, in accordance with some embodiment;

FIGS. 14-19 are example illustrations of a platform for presenting customized media on an user device, in accordance with some embodiment;

FIGS. 20-27 are example screenshots of a first customized video or animation, in accordance with some embodiment;

FIGS. 28-31 are example screenshots of a second customized video or animation, in accordance with some embodiment;

FIGS. 32-39 are example screenshots of a third customized video or animation, in accordance with some embodiment; and

FIGS. 40A and 40B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The term “device” as used herein is intended to refer to any device which a user may utilize for viewing media. Often these devices are also referred to as “mobile devices” as one focus of such media platforms is with devices such as laptops, cell phones, and tablets. However, it should be understood that any device where media may be viewed falls within the scope of the term “device”.

Moreover note that the term “media” is commonly used to refer to video or animation content. However, the term ‘media’ is intended to be applied more broadly to any content that may be customized to result in greater user relevance. This may include images, text, email, audio or the like. Also note that video or animation may compose digitally rendered moving images using HTML or Flash, may include actual live-action filmed content, or any combination thereof. As such, the term “video” or “animation” are intended to be utilized interchangeably and refer to any multimedia presentation that includes moving images, figures or objects.

Also note that the term “user” is utilized to describe the user of a device who is consuming the customized media. It is likewise understood that the terms “participant”, “customer,” “media consumer”, and “viewer” are likewise often utilized interchangeably with the term “user”.

Note that the following disclosure includes a series of subsections. These subsections are not intended to limit the scope of the disclosure in any way, and are merely for the sake of clarity and ease of reading. As such, disclosure in one section may be equally applied to processes or descriptions of another section if and where applicable.

### I. Media Customization Systems

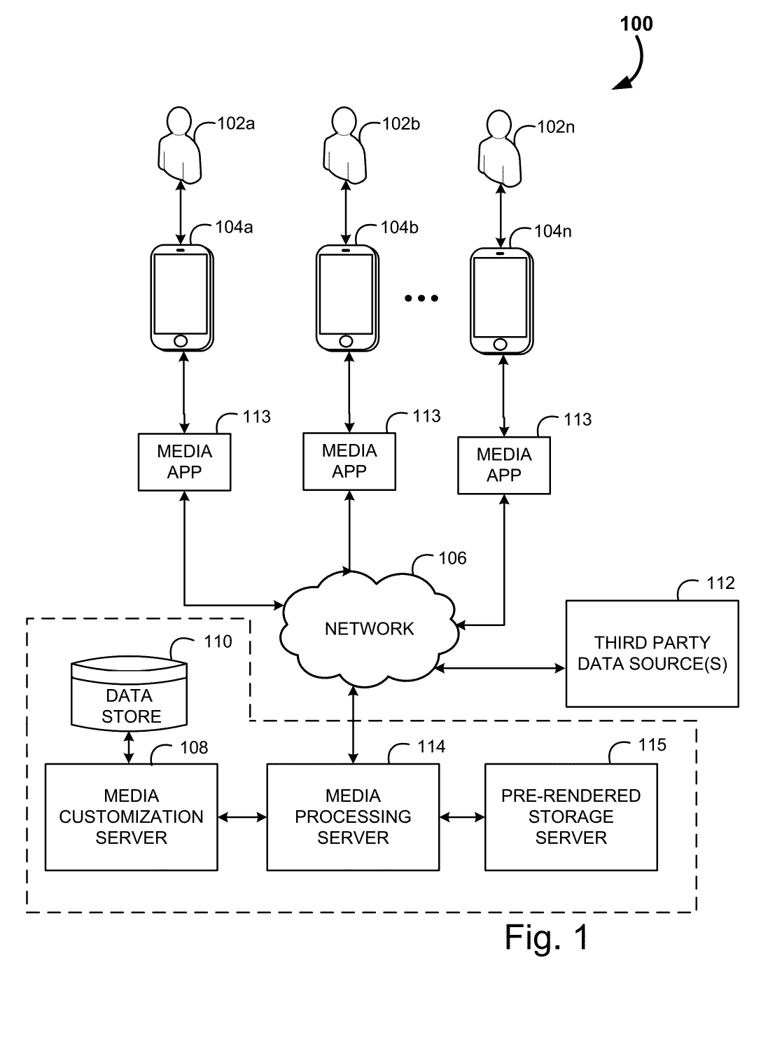

To facilitate the discussion, FIG. 1 is an example logical diagram of a system for generating and presenting customized media, shown generally at 100. In this example block diagram, a number of users 102a-n are illustrated engaging a plurality of devices 104a-n. Note that media may be uniquely customized for each user 102a-n in some embodiments. In alternate embodiments, users may be grouped by some common attribute. Content may then be customized for the common attribute. This reduces the processing requirements for the generation of customized content, while still producing highly relevant media for the users 102a-n.

Note that while a one-to-one ratio of users to device is illustrated, for the sake of simplicity, it is entirely within the scope of this disclosure that there may be multiple users 102a-n on any one device if they are concurrently located, or one user 102a may have multiple devices upon which customized media may be viewed.

As previously noted, devices 104a-n may refer to any number of device types, not only cell phones as illustrated herein. In some embodiments, the systems and methods disclosed herein may be particularly formatted in order to operate on such mobile devices, since users are increasingly accessing content via mobile platforms and via mobile applications (“apps”); however, in alternate embodiments the systems and methods of presenting customized media disclosed herein are equally able to be implemented on a wide array of devices (i.e., laptop and desktop computers, game consoles, media centers, etc.).

The devices 104a-n couple to a media app 113 accessed through a browser or on an app on the device itself, which couples to a media customization server 108 via a network 106. The network 106 most typically includes the internet, but may also include other networks such as a corporate WAN, cellular network, electronic medical records platform, PACS distributed system for sharing radiology data and images, lab information system, or combination thereof, for example. The processing server 113 may distribute customized content generated via a customization server 108 (or required data to render said content) to the various devices 104a-n. The customization server 108 may access a data store 110 for device/participant credentials, to access user activity history, access pre-rendered content for streaming, or access stored user data or information for the generation of customized media. The processing server 113, customization server 108, data store 110, and pre-rendered storage server 115 (discussed below) collectively make up the customization system (indicated by the dashed lines).

One or more third party data sources 112, may partner with a processing server 114, where algorithms are applied which identify a target population for a given media, and formulate data in order to create customized media for each member. Data for the target population and customized media is stored in the data store 110. Components of that data are pushed to the media customization server 108 in order to provide reference sites, user specific information, or reference data. Note that while the data sources 112 are referred to as “third party”, this does not require the data to be received from different legal or physical entities. The designation “third party” is merely intended to indicate that the data is being received from a source that is external to the data stores located in the devices 104a-n or from the servers 108 or 114.

For Pre-rendered videos, an additional step takes place whereby a Pre-rendered Video Storage Server 115 creates and stores the pre-rendered videos by calling data from the media customization server 108 to determine what data populates the videos being rendered. This pre-rendered video storage server 115 is only relevant for a system using pre-rendered videos.

A User identifies him/herself to media app 113, which compares against credential information in the data store 110 that is accessed through media customization server 108. Based on the user identification, the media app 113 calls media customization server 108 to display data for the video, sending a different response depending on if it is dynamically- or pre-rendered. In the dynamically-rendered system, the media customization server 108 sends data to the media app 113 to dynamically draw motion graphics and characters into the customized media. In the pre-rendered system, the media customization server 108 returns a specific video to the media app 113 to display.

For example, in the context of healthcare education, the third party data sources 112 could include data or information from insurance companies, employers, or health care and pharmacy service providers. These sources can provide information such as user insurance plan benefits details, human resources eligibility feed data, diagnostic information, medical or pharmacy claims information, diagnostic information, or the like. Note, within this disclosure, a number of examples will be provided within the context of healthcare education via customized videos. Media customization may be ideally suited for such circumstances, as understanding medical plans, insurance requirements, and disease and treatment specifics is often confusing for most people. By incorporating user specific data or information into video or animation presentations, users are more likely to be actively engaged in their healthcare decisions and to be more informed consumers. However, the media customization processes and systems disclosed herein are equally applicable to contexts outside of health care. As previously noted, any circumstance where user engagement, via the provision of more relevant content, is desired may be subject to media customization. This includes education, marketing, and communication contexts. It is thus intended that the instant disclosure not be limited to any specific field (such as healthcare) or any specific application (such as education). Users can be either consumers (“B to C” applications) or businesses (“B to B” applications).

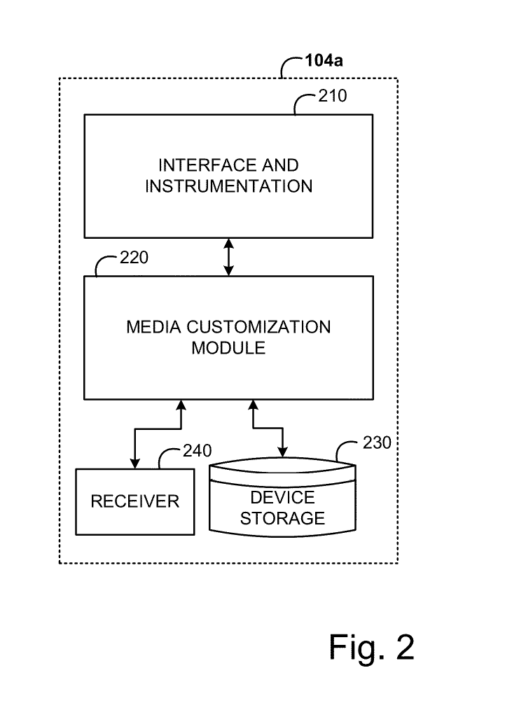

FIG. 2 is an example schematic block diagram for a user device 104a used in conjunction with the media customization system 100. In this illustration, the device is seen as including at least one interface and the instrumentation 210 required to effectuate the consumption of customized media. At a minimum this includes one or more displays and at least one input device (touch screen, keyboard, etc.). It may also include a speaker, in some embodiments. The device 104a also requires a means to transmit data to and from the network 106. This may include a Wi-Fi connection, cellular connection, or other connection type (receiver 240) as is appropriate for the present device 104a. In some alternate embodiments, not illustrated, rather than having a connection to a wider network, and ultimately the server, the device may include internal logic capable of generating the desired customized media. In a similar vein, devices may occasionally be unable to establish internet (or cellular) connectivity with the network, and may be configured to have the ability to download required media data ahead of time in order to be able to still provide customized media even when disconnected from the wider network.

In addition, it may be desirable to have additional functionality that required specialized instrumentation, such as a microphone, GPS, motion detectors, biometric collectors, temperature sensors, etc. These additional functionalities may be employed to collect additional user data or information for further customization of media in some embodiments. For example, user location, as determined by a GPS, could be employed in some embodiments to provide suggestions of close services within the media being presented.

The instrumentation and interface 210 couples, physically or logically, with a media app 113. In the case of a desktop implementation, the instrumentation and interface 210 connects with the media app 113 via a browser and a receiver 240. The media app typically includes computer readable instructions on non-volatile device or webserver-level storage 230, and executed via one or more processors.

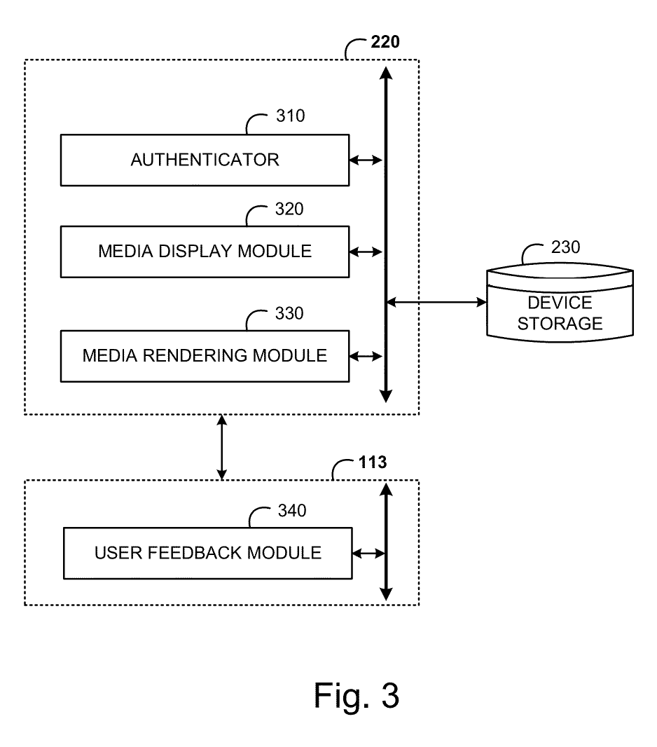

FIG. 3 provides a logical diagram of the media customization module 220 within the user device 104a. The media customization module 220 includes an authenticator 310 which may accept user credentials in order to ensure the identity of the individual. It is important to deliver the proper media to the correct individual in order to be effective. Indeed, if customized media is misdirected toward the improper user, the content may be off-putting or confusing. Additionally, if sensitive user data or information is incorporated into the customized media, it is likewise necessary to ensure the media is provided only to appropriate recipients in order to maintain privacy. These types of security may include, but are not limited to: authentication that uses individual-specific data such as any combination of Social Security Number, Date of Birth, Last Name, Member Insurance ID; role-based permissions and role-based actions, based on job title, specific geographic location, or other factors to limit who sees what customized media; access to the service or specific animations only over secure networks including Virtual Private Networks; fingerprint touch identifier; two-factor authentication using a mobile phone; etc.

A media display module 320 coordinates the user account data and customized media that has been generated for the user, and compiles the information into a user-friendly interface for display on the device 140a. The customized media being presented by the display module 320 may be pre-rendered on the media server 108 and streamed over the network 106, or may be downloaded prior to displaying and saved internally on the device or webserver-level storage 230. Alternatively, the device may render the customized media internally at the media rendering module 330.

One potential reason for requiring on-the-fly rendering is if user input is needed for the customization. In such circumstances a user feedback module 340 may collect the users input and incorporate it into the user's data or information for customization. Often the user input takes the form of an answer to a question, and may employ touch-screen interface features of the device (or any other input means, such as mouse selection, keyboard input, microphone, etc.). While simple question-and-answer style inputs are often preferred in order to collect target information from the user, the on-the-fly systems and methods are also readily capable of receiving a wide variety of user inputs for incorporation into the customization of the media, in some embodiments. In addition to collecting user inputs for customizations, the user feedback module 340 may also collect general user activity.

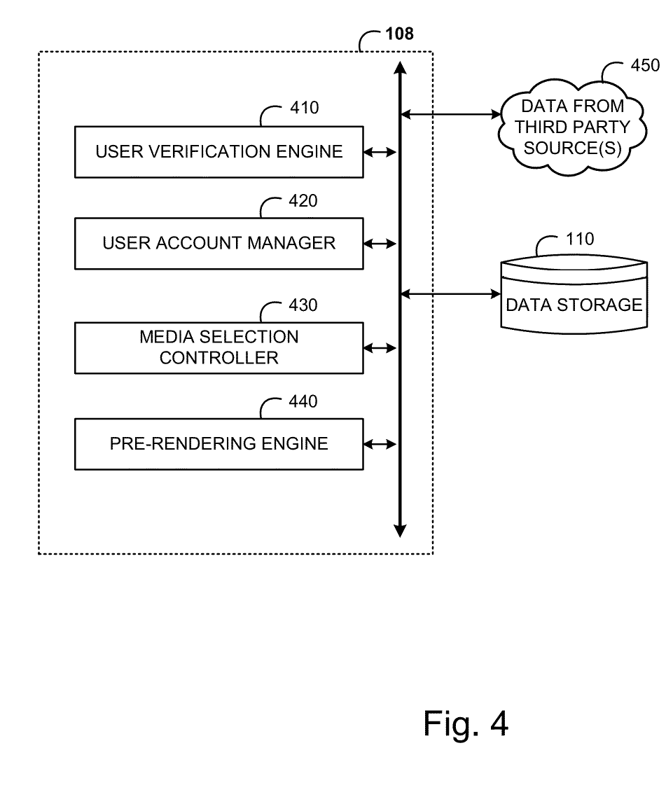

Continuing on, FIG. 4 is an example logical diagram of the customized media server 108. The customized media server 108 includes a user verification engine 410, which may be utilized to verify the users identity for the reasons previously discussed. Usernames and passwords may be received via the network 106 from the device 104a in order to determine the authenticity of the user.

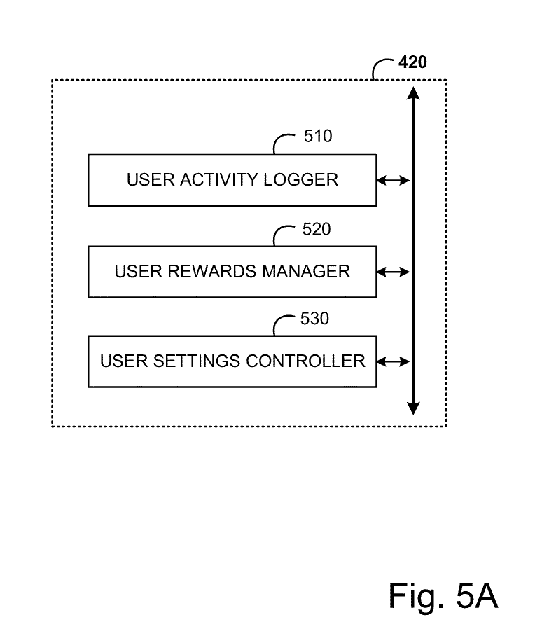

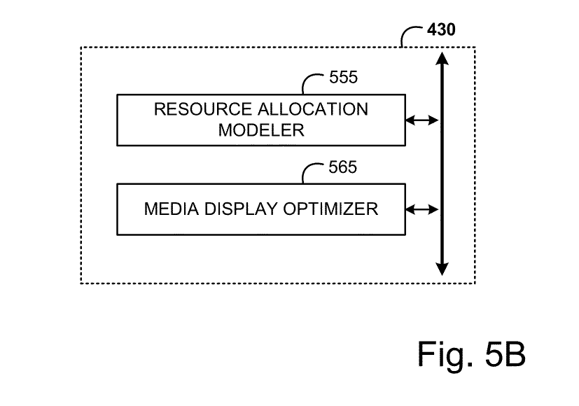

A user account manager 420 receives information regarding user settings from the user device 104a. FIG. 5A provides a more detailed view of the user account manager 420, which includes a user activity logger 510 for keeping track of user activity, a user rewards or penalties manager 520 which may track rewards or penalties the user has earned or may gain via particular activities (or lack thereof), user settings controller 530 which may be utilized to manage the account layout.

User feedback that is collected in the user feedback module 340 as part of the media app 113 is processed and stored in the media customization server 108 which may then change current or future customized media presented to the user.

A media selection controller 430 determines what media is to be presented to the user.

Returning to FIG. 4, a media selection controller 430 may also be seen as part of the media customization server 108. FIG. 5B provides an example logical diagram of the media selection controller 430. The media selection controller 430 includes, a resource allocation modeler 555, and a media display optimizer 565, in some embodiments. The media display optimizer 640 may be configured to prioritize the order and means of media presentation to the user. Typically the media display optimizer 640 will ensure most relevant media is available to the user first, as well as more broadly applicable media, more specifically tailored media, or that of less relevance to the user may be offered to the user as well, but may take less priority than the more relevant media.

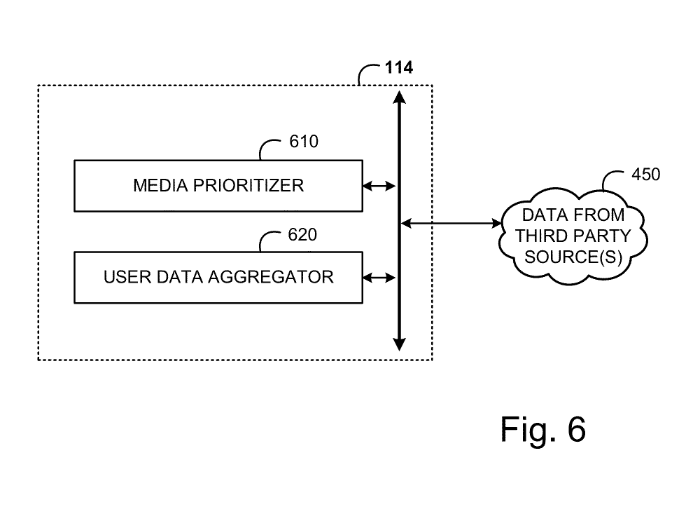

FIG. 6 shows an example logical diagram of the processing server 114, which may include a media prioritization component 610, and a user data aggregator 620. As noted above, the processing server connects to a third party data source 450, processes that data into a usable form, and then moves that data into the data storage 110. The media prioritization component 610 may receive rules from an account administrator, interested third party, or the user in order to generate a set of rules used to determine which media to provide to the user. For example, in an employer healthcare portal setting, the employer may mandate that certain content is provided to the user. Likewise, sponsored content from a third party may be presented if certain conditions are met by the user. Again, in the healthcare example, if the user takes certain prescription medications for a particular ailment, for example, related media directed toward that ailment or those types of medications may be presented. Lastly, the user may provide input on which content is desired to be received. The media prioritization module 610 enables the generation of machine readable rules to prioritize and designate which content is relevant to the user and should be presented.

The user data aggregator 620 may collect user data or information 450 from third party sources, internal storage, or data collected from the device 104a.

Although not illustrated, the pre-rendered video storage server 115 includes a number of sub-processes. The pre-rendered video storage server 115 may only be used for a pre-rendered system, in some embodiments. As noted above, this makes calls to the media customization server, which passes data used to render and store videos in the pre-rendered video storage server 115. This then passes fully-rendered videos to the media customization 108 server. The pre-rendered video storage server 115 includes a resource allocation modeler capable of determining how processing and storage resources should be applied. For example, when pre-rendering media for a very large number of users, often the media is not ultimately viewed by the users. However, due to the large volume, the processing and storage requirements can be very large. When multiple pieces of media content are vying for common resources, a resource modeler may be beneficial to plan the most optimal execution of rendering activities, and the length of time content is stored.

### II. Methods of Media Customization

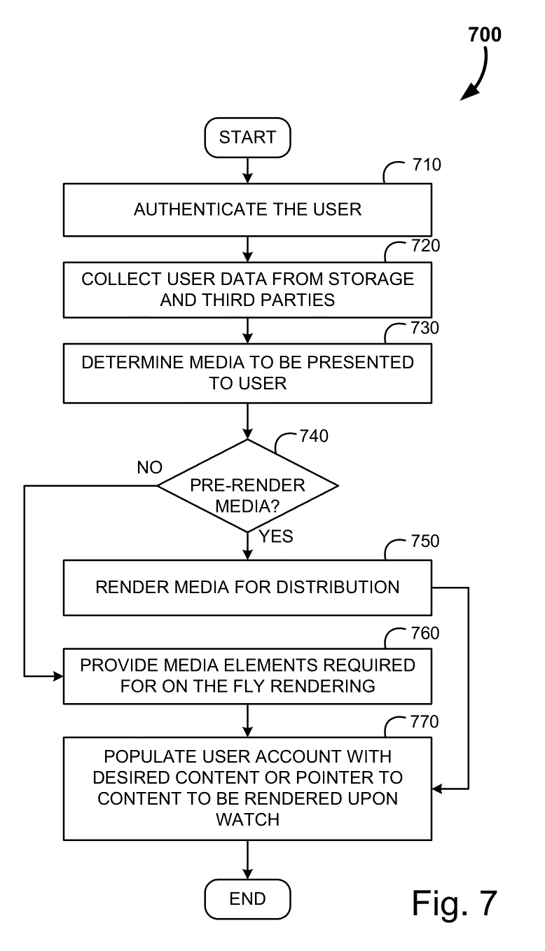

Now that the systems for media optimization have been broadly described, attention will be turned to processes employed to generate and present the customized media. In FIG. 7 an example flow diagram for the presentation of customized media is provided generally at 700.

In this example process, the user is initially authenticated (at 710) by any known methods of authentication. This may include username and password combinations, biometric identification, device credentials, etc. After user authentication the user's data or information is collected from storage and third parties (at 720). User data or information may include any relevant data or information that may assist in the generation of the customized media. For example, in the context of healthcare, insurance plans available, health insurance claims, non-covered services, out-of-pocket payments, medical diagnoses, prescription drugs filled, and medical treatments received, etc. may all be considered relevant for the generation of customized media. This data or information may be received from insurance carriers, physician records, electronic medical records, medical and prescription claims data, human resource feeds, or direct input from the user.

In a marketing context, previous consumer choices and compliance, credit rating, reviews a user had for products, and personal details may all be compiled in order to generate highly customized media for the user. In yet another context of political advertising, details about the user's ideological stance, demographics, occupation, and local interests may be particularly helpful in generating customized content. Thus, clearly, the data or information useful in the customization process is highly dependent upon the kind of media being generated.

Note that care must be taken to ensure, based upon the context, that the appropriate level of customization is undertaken. For example, within the healthcare setting, the user is aware that the media is being prepared in conjunction with an employer, insurer, or other trusted partners with access to very sensitive user data or information. As such, the user may expect to have detailed medical knowledge incorporated into the media. In contrast, media produced to advertise to the user may be less intimate in order to avoid making the user uncomfortable. One way to address this potential discomfort is to allow the user to opt into receiving either generalized or more personal information and even to determine the level of personalization. Even though many users have considerable amounts of data or information about them available in the public domain, they may still harbor a desire for privacy and anonymity and a belief that their information is private. Providing information which a user considers too individualized or sensitive may alienate the user, instead of drawing them in. As such, user input may be used to gauge the level of personalization desired by each individual, or group of individuals, and user reaction to any given customized media may be analyzed to determine the degree of customization that yields optimal results.

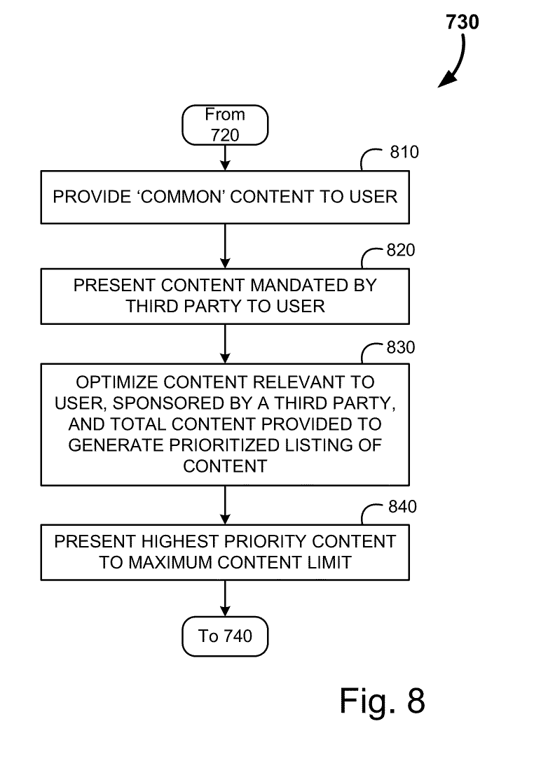

After the required user data or information has been collected, the process continues by determining which media is to be presented to the user (at 730). FIG. 8 explores this process for media determination in much greater detail. Initially, common content may be provided to the user (at 810). Typically, the presently disclosed media customization takes place in a narrow contextual environment, such as a healthcare portal, as part of a retailer web environment, or the like. Often, given the media's context, certain basic content is desired for the majority of users. Again, returning to the healthcare example, a basic overview of healthcare terminology may be common to all users. This kind of content may be prioritized and distributed to users as a matter of course.

Additionally, there may be content that a third party mandates be distributed to users. Such content could be, for example, sponsored products or services. This content may also be prioritized and distributed to users (at 820). After required content has all been distributed to the users, the system begins the more complicated task of determining what additional content would benefit the user (or otherwise effectuate a given goal).

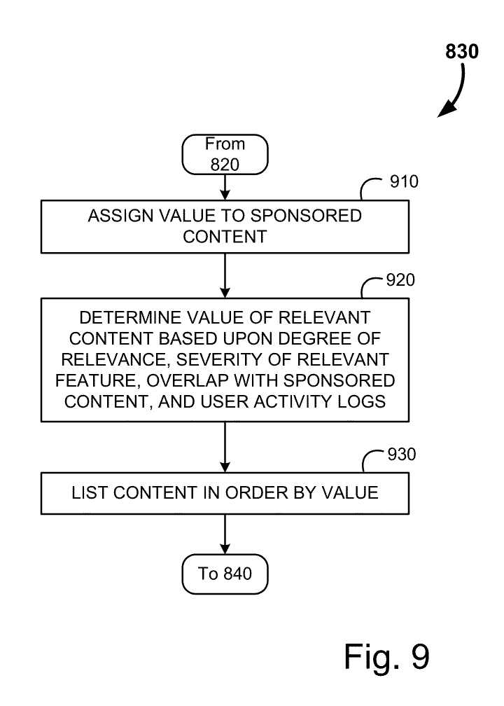

User preferences, content that is relevant to the user, optional third party sponsored content, and total content may each be optimized to generate a prioritized listing (at 830). This can be accomplished using any number of techniques; however, FIG. 9 provides but one example flow diagram for the process of optimizing content to a user, in accordance with some embodiment. In this example, a value is assigned to all optional sponsored content (at 910). This value may be based upon a number of factors, but may result from contractual agreements for the frequency that the third party content is required to be presented to a user.

Next, content that is relevant to the user is assigned a value based upon degree of relevance to the user (at 920). This value may rely upon models that determine the likelihood that the user would be interested in the content. For example, retailers such as Amazon already perform sophisticated models to determine what products and services a user would be interested in based upon prior shopping history. Such models could easily be extended for the generation of values for content related to goods and services (in an advertising context). Likewise, in a healthcare context, prescription and medical history data can be mined to determine likelihood of the user suffering from a medical condition. In the event a condition is highly likely, content related to the condition may be assigned a high value. Less likely conditions would respectively receive a lower value. If sponsored content overlaps content that is deemed relevant to the user, the value for the media may also reflect this accordingly.

Lastly, in this example process, the content can then be listed by value (at 930). Thus, content that is heavily sponsored and particularly relevant to the user is prioritized over less relevant content. Returning to FIG. 8, after the content has been optimized, the highest priority content is presented to the user (at 940). Typically, given screen size, and the fact that people only want to see a limited number of media selections at any given time, a limit is set for the maximum number of content segments to be presented to the user. In some cases the user sets this content limit in the settings. Other times this maximum number is a function of the device (devices with smaller screens have lower limits compared to devices with larger screens).

Returning to FIG. 7, after the media to be presented is determined, a decision is made as to whether to pre-render the media or have the media rendered on-the-fly within the device (at 740). Note that in alternate embodiments, the decision of whether to pre-render or not may be determined and configured by developers initially. In yet other embodiments, no pre-rendering is possible, and virtually all media may be generated on-the fly by the user device. As devices become more powerful, it is expected that more and more content will be rendered on-the-fly rather than relying upon pre-rendering.

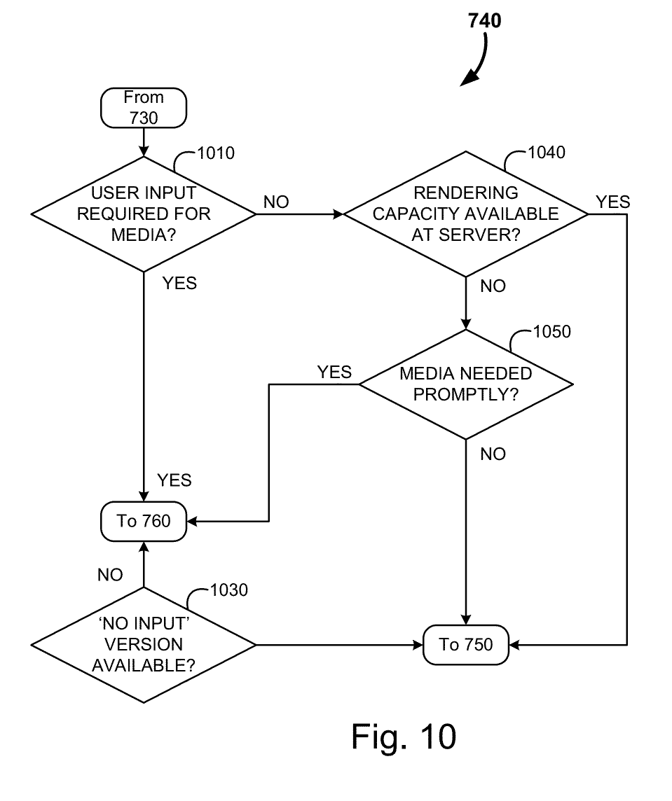

FIG. 10 provides a more detailed example flow diagram for this process of determining whether the media is to be pre-rendered, in accordance with some embodiment where such pre-rendering is being used. Here, initially a determination is made as to whether additional user input is needed for the media to be customized (at 1010). Sometimes the data sources relied upon are incomplete, or assumptions need to be made based upon data that are not guaranteed to be accurate. In these circumstances, it may be necessary to query the user to fill in or confirm incomplete data and therefore enable the full customization of the media. In other circumstances, user engagement can be purposefully increased via requests for user input, even if the input isn't strictly necessary to continue the customization. In other situations, even if all relevant data for pre-rendering are available, the decision may be made to have media rendered on-the-fly in order to avoid storing large amounts of pre-rendered data that may not be viewed. In such circumstances, the size of a given media segment, numbers expected, and probability of the media being viewed may all be taken into account in order to determine whether it makes sense to have the media pre-rendered, or whether the storage cost to value ratio is too low to warrant pre-rendering.

Returning to the initial determination of whether user input is required, if it is not, a determination is made as to whether rendering capacity of the media server is available, adequate, or affordable (at 1040). If so, then again, the media may be pre-rendered within the media server (at 750) rather than relying upon the user's device. Alternatively, if rendering server capacity is unavailable, inadequate, or unaffordable, a determination is made as to whether the media is needed promptly (at 1050).

In alternate embodiments, the determination on whether to pre-render versus render on-the-fly on the user's device may be based less upon processor capacity, but rather upon storage costs versus benefits of pre-rendering. In a pre-rendered system, the media needs to be customized and prepared for each potential user, even if that user never views the content. Under such a calculus, the likelihood of an animation being viewed is compared against the storage requirements of pre-rendering, Such a system may result in considerably more content being rendered dynamically on user devices, leading to enhanced scalability.

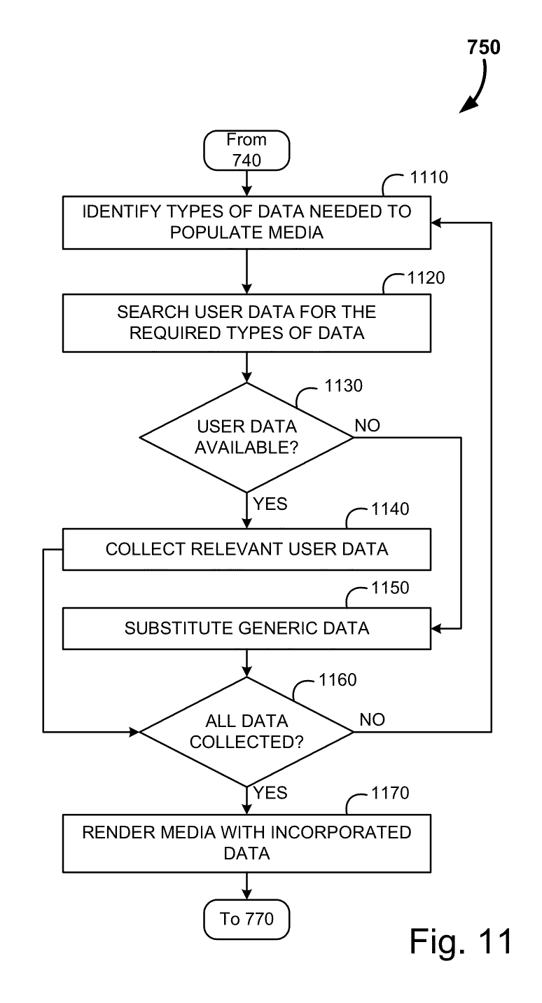

Turning to FIG. 11, the sub-process of pre-rendering the media is described in greater detail, shown generally at 750. First, the types of data or information required to populate the customization are identified (at 1110). For video and animation media, often the media are provided as a template that includes fields that require population with the user's data or information. These fields are identified by the kind of data or information with which they are supposed to be populated. For example, a field may require the user's name to be inserted. Using a human resources feed, social network data sources, or the like, the user's name may be identified for pre-populating this field.

The user data or information that has been compiled from third party sources, provided by the user, or otherwise known, are then searched for data or information types that match the required types to populate the fields (at 1120). A determination is made as to whether all the required data or information are available, given the existing pool of data or information for the user (at 1130). If not, the system may be required to find alternative user data or information (at 1150) by querying other data sources, or even requesting the data or information directly from the user, in some embodiments. Alternatively, ‘generic’ data may be substituted for the user's specific data or information. For example, if the user's name is not found, and a field requires the person's name, a generic term like ‘friend’ could be substituted in the place of the user's name. Thus instead of the video displaying “Hi Bob!” it would state “Hi friend!” for example.

Likewise, if the user data or information is available from existing data sources, then the requisite data or information may be collected by the system for incorporation into the appropriate field (at 1140). Regardless of whether user specific data is used to fill the field, the next step is to determine if all data or information for the required fields has been collected (at 1160). The data or information is then incorporated into the media and it is rendered (at 1170) for storage and ultimate distribution to the user's device.

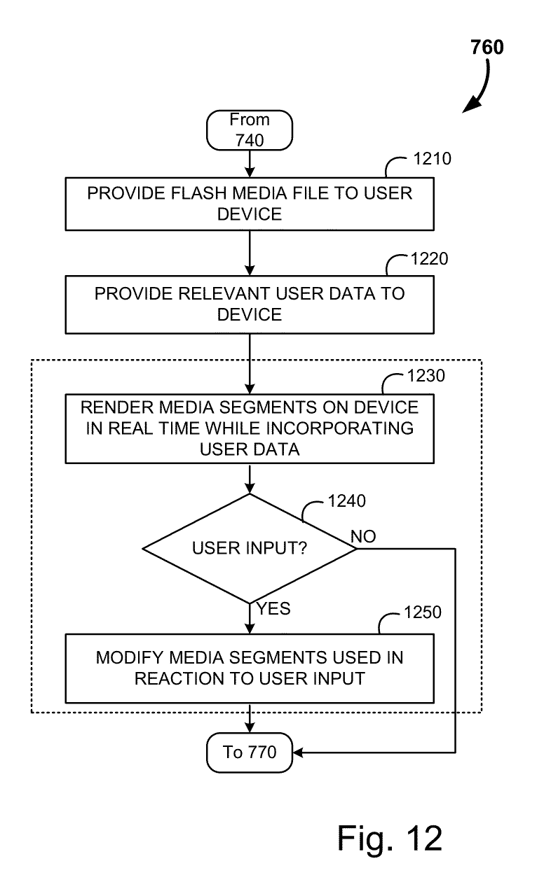

In contrast, FIG. 12 is an example flow diagram for the process of on-the-fly media rendering within the user's device, shown generally at 760. In this process, the media server provides the flash media file to the user's device (at 1210). Likewise, a list of the data or information the media server has access to, which is relevant to the customization, is likewise provided to the user's device (at 1220).

The remaining steps for on-the-fly rendering occur in the user's device, as is illustrated by the dotted outline surrounding them. The media segments for which user data is available are rendered in real time (at 1230). A determination is made is user input is required (at 1240), and if so, the media segment utilized can be modified in response to user inputs (at 1250).

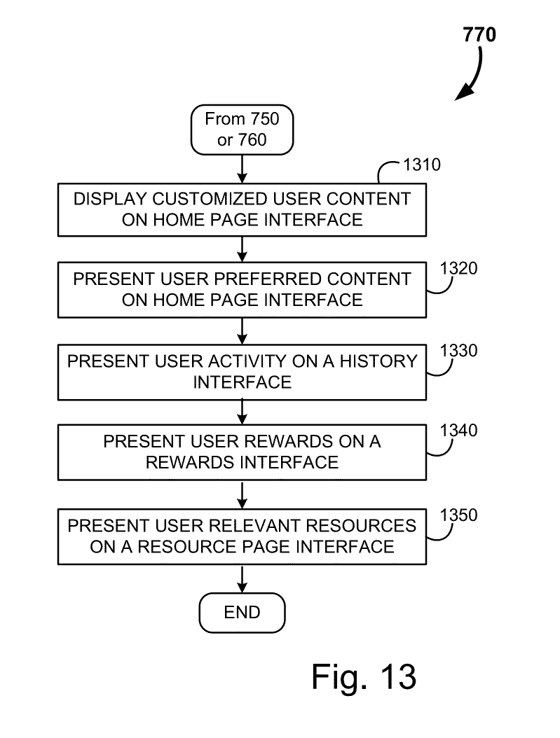

Returning to FIG. 7, if the media is pre-rendered, after the customized media has been rendered, the process continues by populating the user's account with the rendered content (at 770). If the media is rendered on the fly, the video is rendered simultaneously with the user watching the video. In the case of on-the-fly rendering, the user's account is populated with a pointer to the content to be rendered when watched. FIG. 13 explores the process of populating the user's account with the customized content in greater detail. In one embodiment of the presently disclosed systems and methods, the user's account includes a number of tabs on an interface dedicated primarily to the delivery of the customized content to the user. In such embodiments, the customized content may be displayed on the accounts home page (at 1310). Additionally, preferred content selected by the user, his employer, his medical provider, etc., may likewise be displayed on the home page (at 1320). For example, the user may wish news feeds, stock tickers, weather, or other data to be readily displayed on the homepage for convenience.

The user's past activity may be logged and presented on a history tab (at 1330). This enables a user to go back and review what content they have viewed, or to otherwise trace their previous activity. User rewards or penalties may be displayed on a rewards or penalties interface (at 1340). Often the viewing of the customized media, or related activities, may be rewarded or penalized using game theory principles in order to promote desired behaviors (such as having a physical, taking a quiz, etc.). Within an educational setting this can be particularly effective in order to promote increased user engagement. Lastly, resources relevant to the user and/or the customized content may be provided on a resource page (at 1350). These resources may vary widely depending upon user needs. They may include embedded internal tools, or may include redirections to third party resources.

Now that an example process for providing customized media has been detailed, a series of examples will be presented to provide context. For the sake of simplicity, the examples provided are all centered on a specific scenario of a healthcare education and resource portal. This scenario is ideal for a number of reasons: 1) the user is a close partner with the employer and insurance provider, thereby presenting a data rich environment for media customization; 2) medical information and health insurance information are very important to the user's physical wellbeing, and may also affect the financial wellbeing of not just the user, but also the employer and insurance provider; and 3) medical and health insurance information are often complicated and confusing for many people, thereby providing rich ground for user education on the subject.

However, it should be noted that while considerable numbers of example screenshots are provided for this healthcare driven example, the disclosed systems and methods for media customization are applicable for many purposes beyond healthcare . For example, advertisers could benefit greatly from customized media. Furthermore, education of any topic beyond healthcare or health insurance could potentially benefit from media customization.

Moreover, the following examples also focus heavily upon video and animated media for customization. While customized videos and animations may be particularly effective as communication tools, it is entirely possible that the media being customized may include audio, written text, static images, or any combination thereof. As such, it is of paramount importance that the following examples provide clarity of the media customization systems and methods without unduly limiting their scope.

### III. Examples

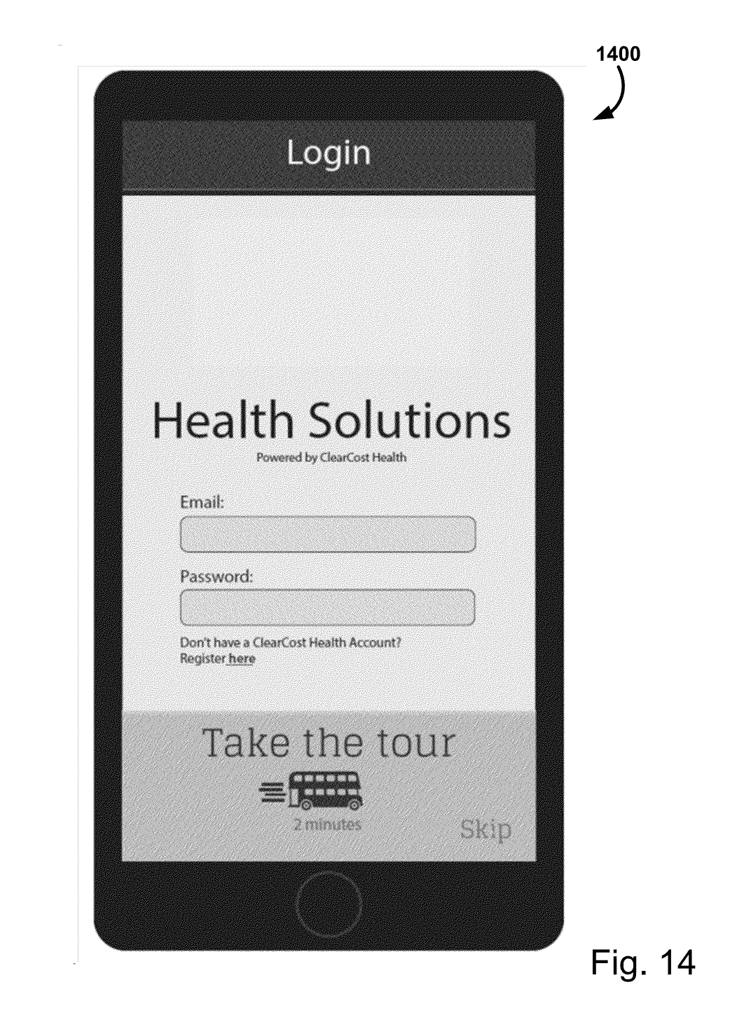

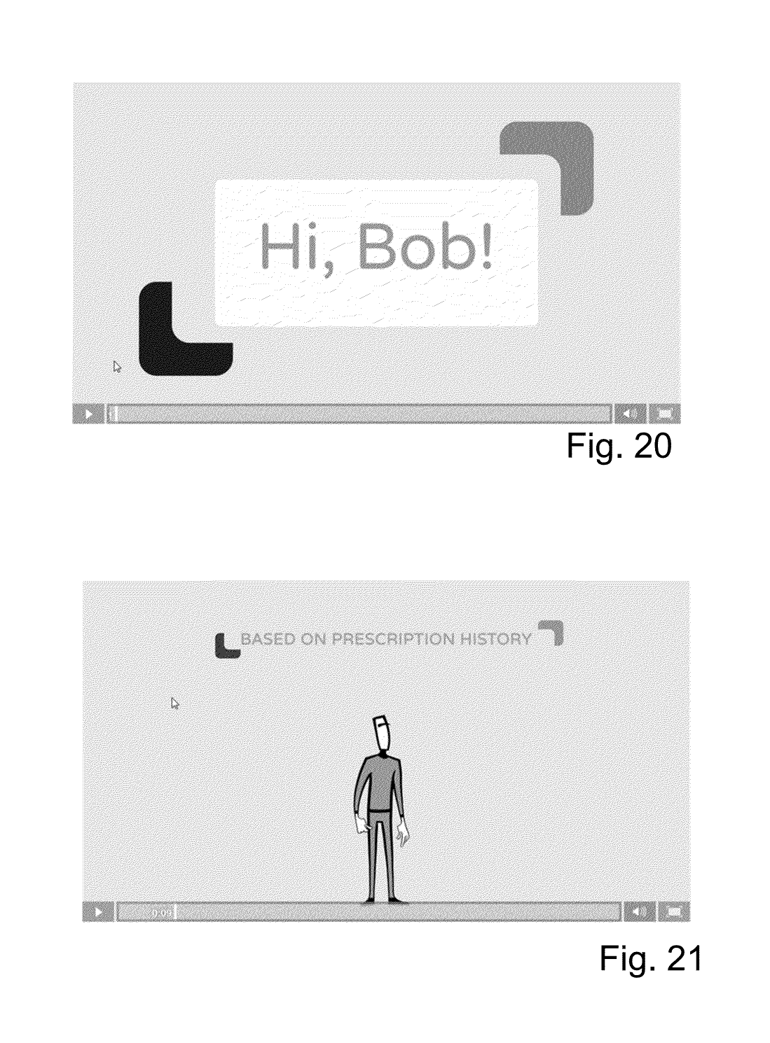

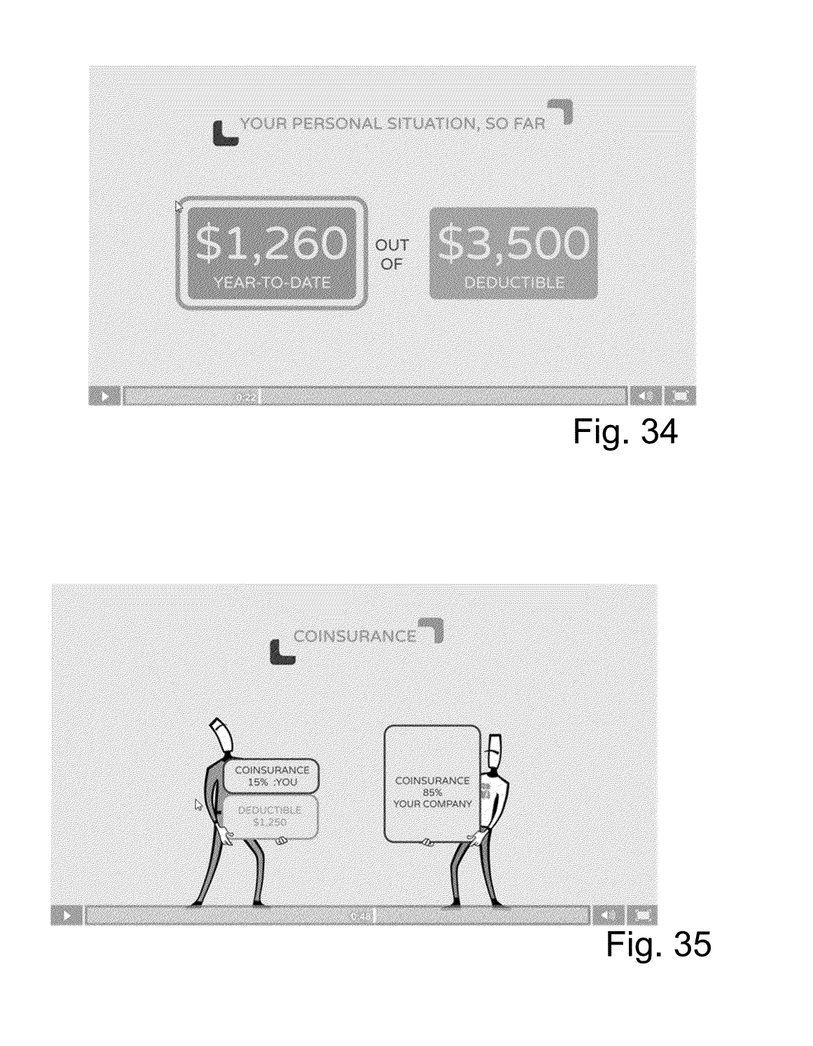

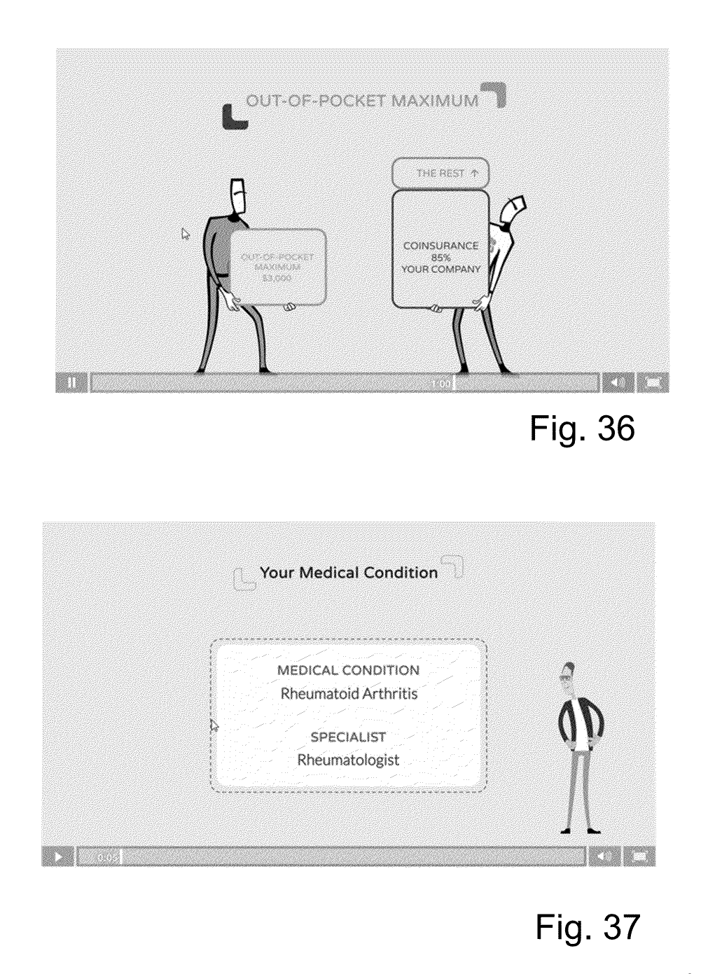

The following examples include platform level screenshots in FIGS. 14-19, and a series of example screenshots of customized videos and animations in FIGS. 20-49. Again, it should be realized that these screenshots are provided by way of example, and do not restrict the scope of the embodiments.

FIG. 14 provides an initial authentication page on a user device for access to a health solution application, shown generally at 1400. As previously noted, the authentication using email and a password (in this example) is important to ensure user identity. This is important so that the user is provided content that is properly customized for them, and also to ensure that the privacy of any user is not improperly violated. Especially within the field of medical informatics, proper protection of patient data is heavily regulated, and breaches of such information may result in considerable liability. As such, proper protections, including adequate authentication, are necessary.

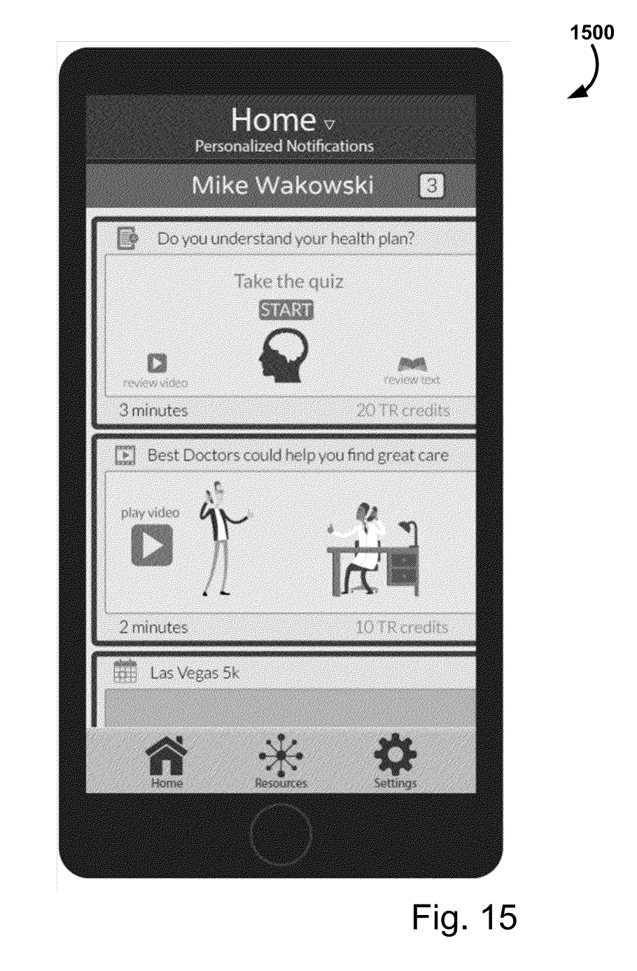

After authenticating, the user is directed to a home page with personalized information, as seen at 1500 of FIG. 15. The home page, in this example, includes a series of videos that are customized for the user. Additionally, user configured data may be displayed, such as a calendar (as seen in this example), weather, message notifications, etc.

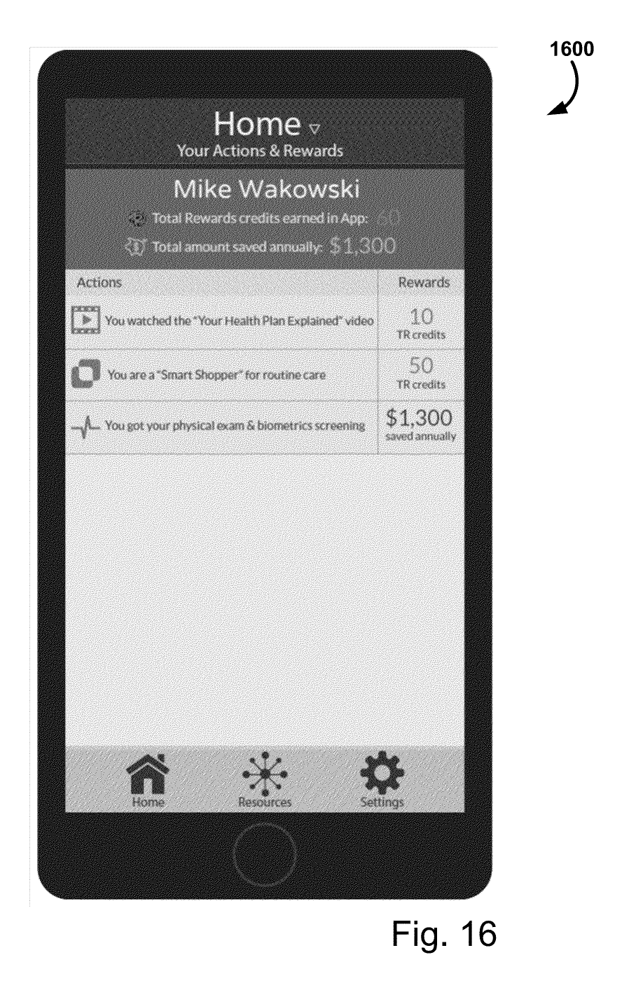

Another page made available to the user is an “Actions and Rewards” page, as seen at 1600 of FIG. 16. In some embodiments, the user's activity logs and rewards may be kept separated, but in this example the rewards are directly tied to the user's actions. As such it makes logical sense to combine these sets of data into a history of activities and resulting rewards earned. In this example, the user is capable of collecting cash rewards for some activities (such as physical exams), and credits for other activities (such as viewing educational media). As is known in game theory, credits may be symbolic, or may be converted into more tangible rewards based upon the system employed.

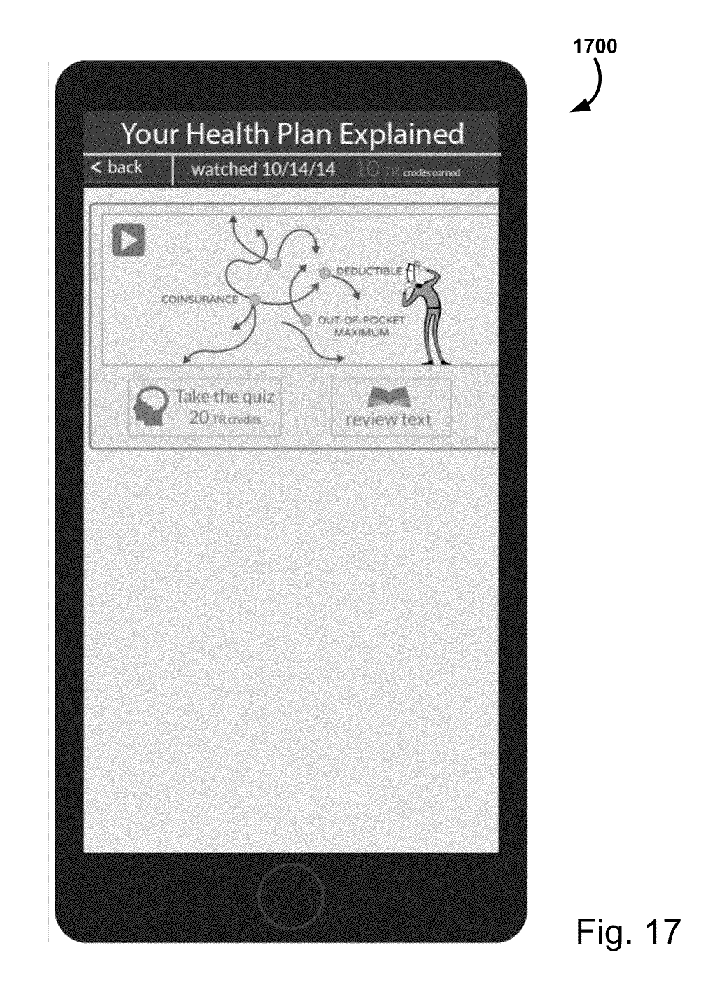

If the user selects from the history an activity performed, a more detailed explanation of the activity, date completed, rewards earned, and follow-up activities may be provided to the user, as is seen in the example screenshot of FIG. 17, shown generally at 1700. Here the user viewed a customized video entitled “Your health plan explained” on a particular date in order to earn 10 credits. In this example, the user has an option to re-watch the video, take a quiz in order to earn additional credits, or review a transcript of the video.

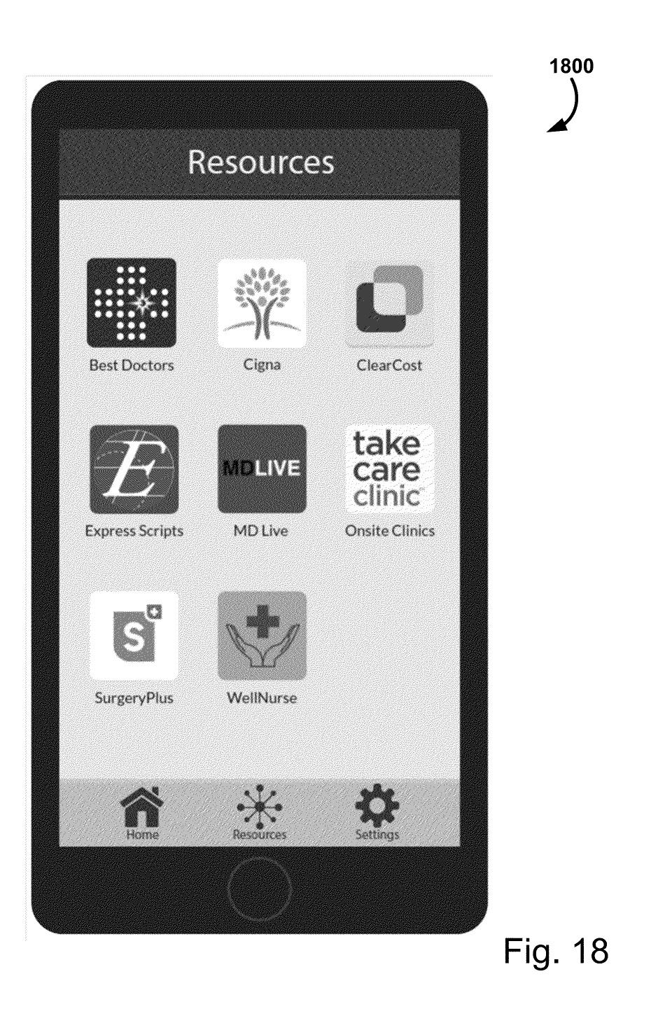

The user also has the ability to access resources, as seen at 1800 of FIG. 18. Typically these resources are elected to meet the needs of the user, and/or are related to the content provided to the user.

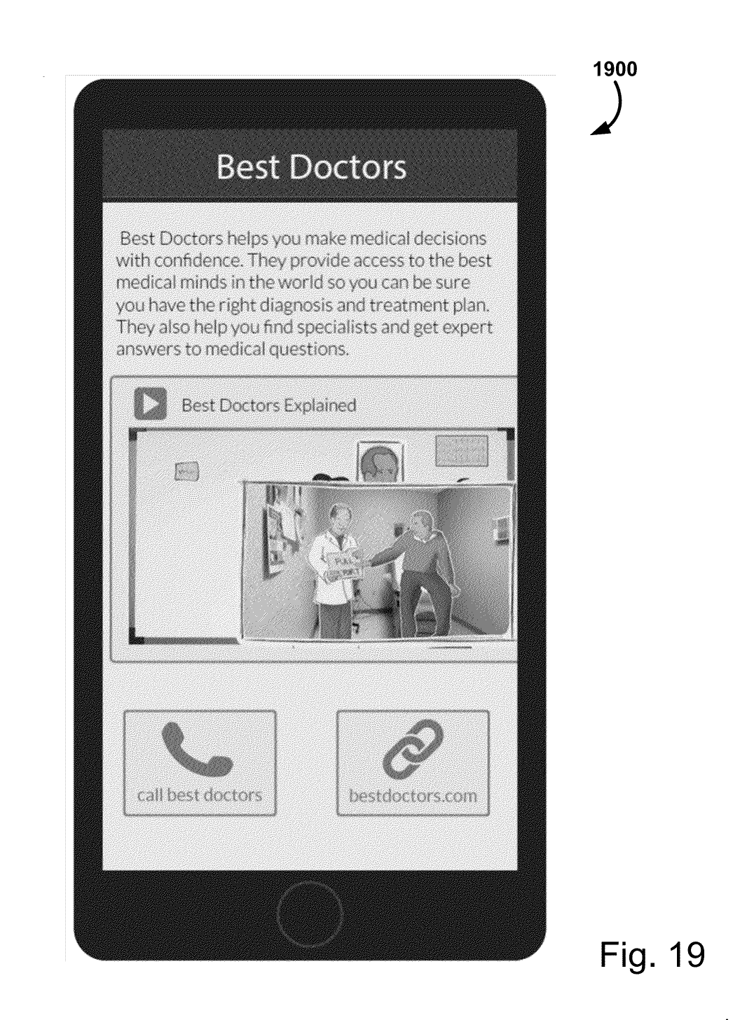

If the user selects a customized video from the home page, in some embodiments the user is directed to a detailed page where the user can find additional information and resources. FIG. 19 illustrates such a page for a customized video, shown generally at 1900.

The following figures are screenshots illustrating the possible customizations to video and animation media in order to increase relevance of the media to a user. In FIG. 20, an opening screen may address the user by name, thereby immediately forming a personal connection with the user. At FIG. 21 an animated character is presented. In some cases the character may be generic for all users, however, based upon rendering resource availability, sponsor preference, and user data availability, it is possible that the character rendered may vary based upon the user. For example, in some cases, a female could be substituted for female users, or the skin coloring of the character could be augmented to more closely match the user. Also in this example screenshot, the prescription drug history of the user is being employed and communicated to the user.

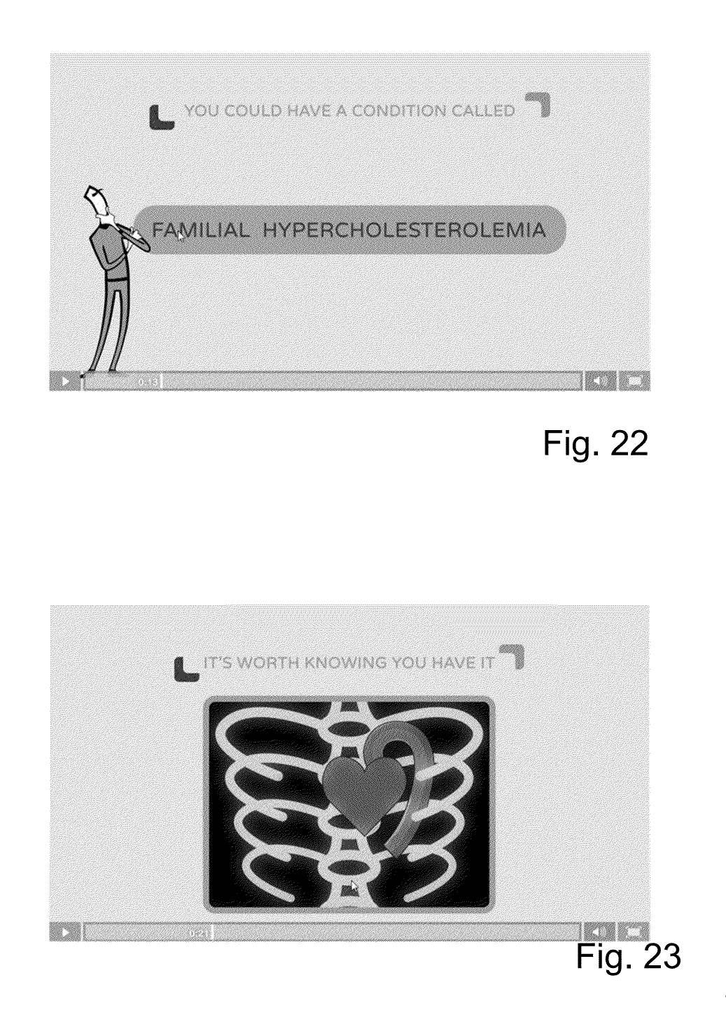

The user data for prescriptions suggests that the user is possibly suffering from a specific condition. This is communicated to the user at FIG. 22. This is followed by education regarding the possible condition, as seen at FIG. 23.

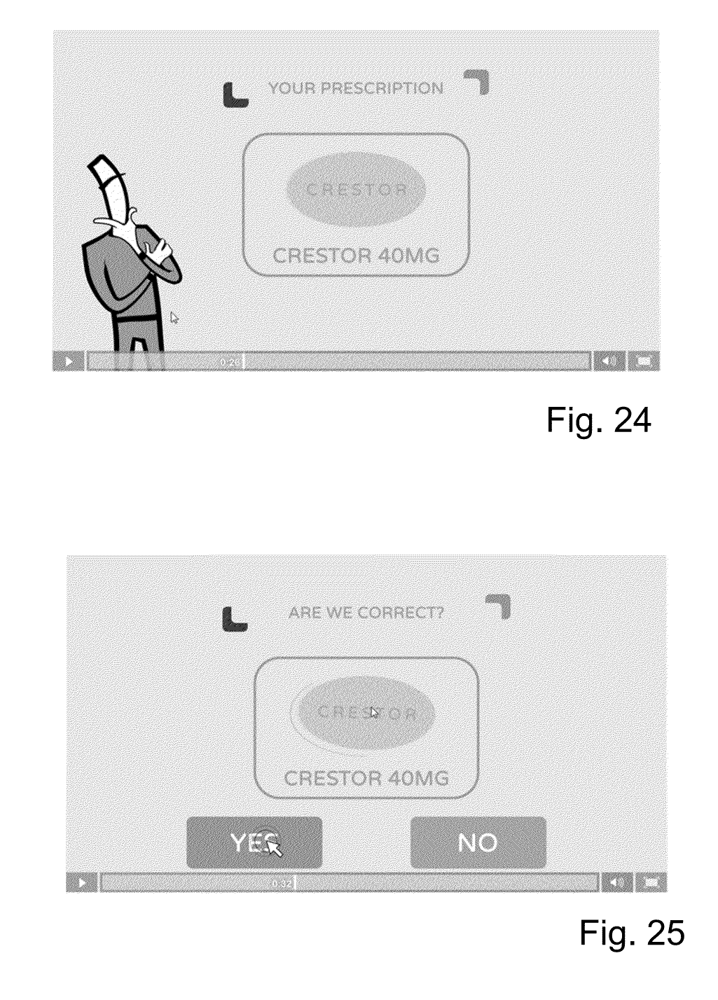

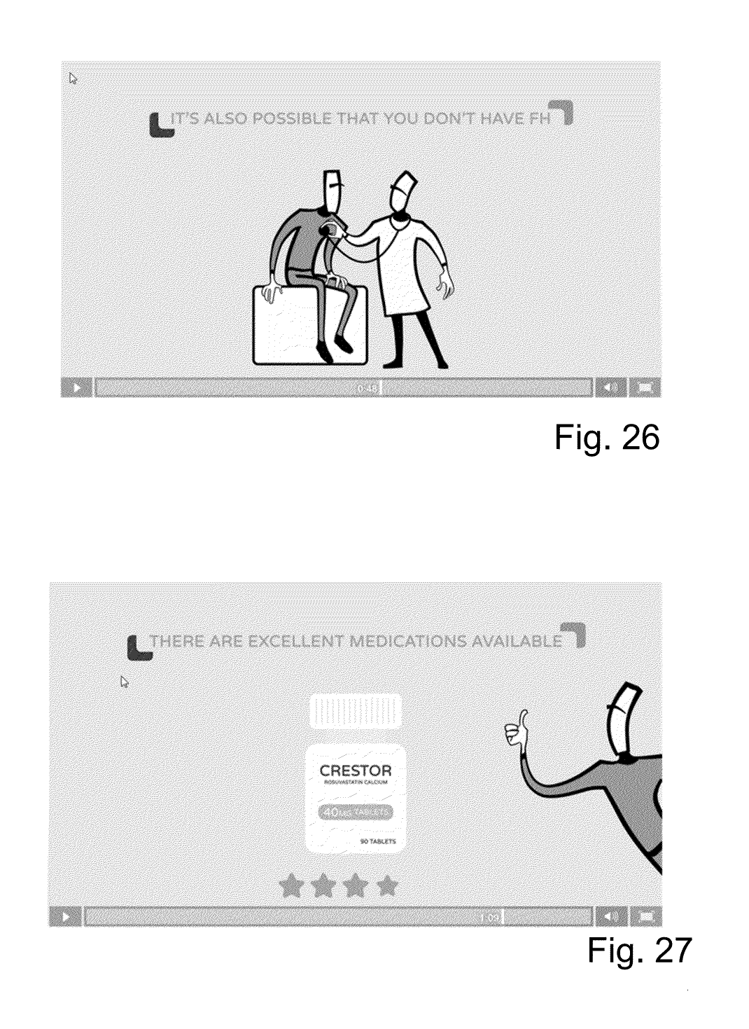

The user's prescription, including dosage, is then shown, as seen in FIG. 24. The purpose of this is to seek confirmation of the pharmacy claims records, as seen in FIG. 25, and also to provide the user assurance that the medical condition being suggested is founded upon accurate prescription data. Since this example video requires user input, it is unlikely that it would be pre-rendered, as the subsequent portions depend upon the user's input at this stage. If the user indicates that the prescription information is correct, then the video may progress to provide additional data or information on the condition. However, if the user indicates that the data or information is incorrect, then the possibility that the user is suffering from the condition identified is eliminated, which would result in completion of the video, as shown in FIG. 26. In contrast, FIG. 27 again incorporates the user's prescription data once it has been confirmed.

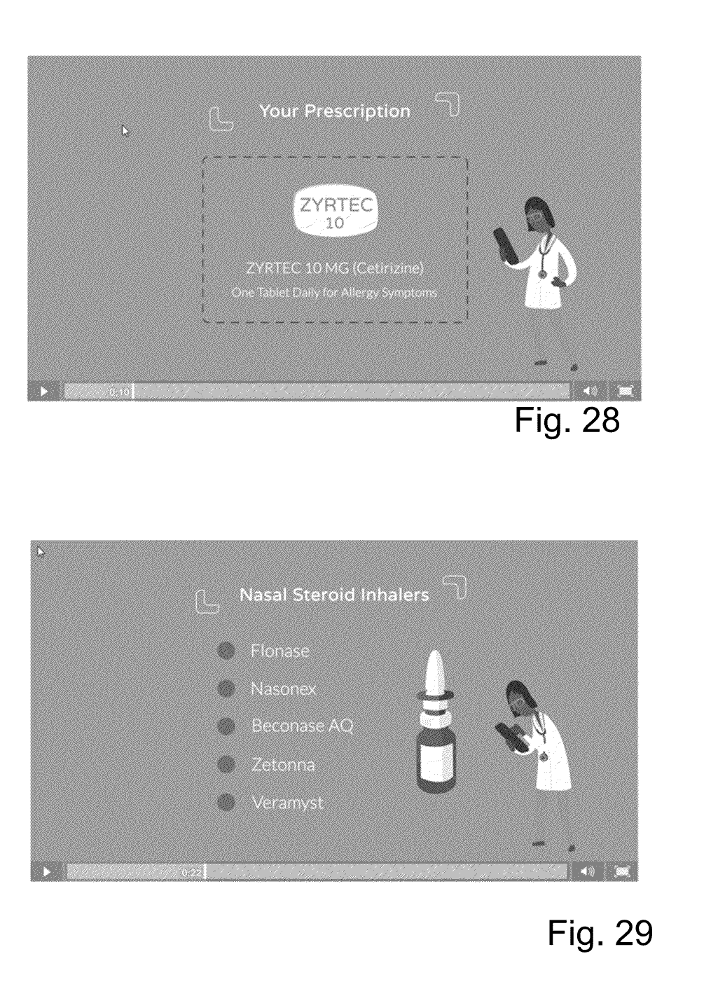

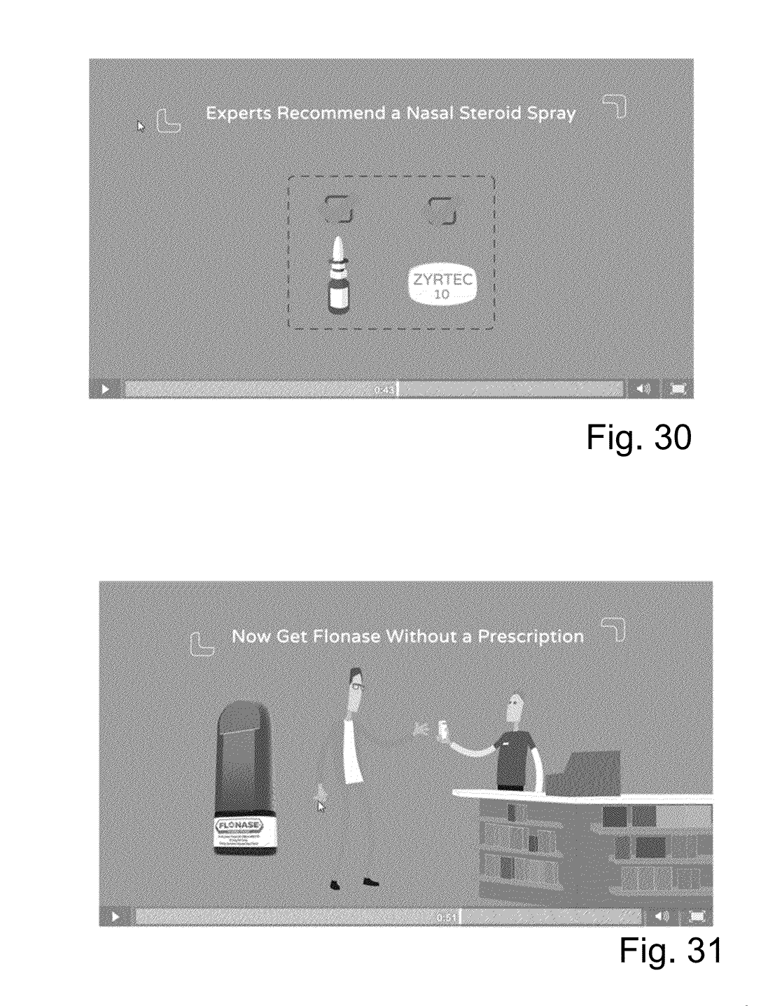

FIG. 28 provides a screenshot from a different customized video where again the user's prescription data is presented. In this example video, the data source for the prescription is considered robust, and therefore confirmation isn't required. As such, pre-rendering of this example video would be reasonable. This example video continues by providing information regarding additional medications that are complimentary to the user's existing prescription, as seen at FIGS. 29 and 30.

The focus of the video shifts at FIG. 31, where a particular brand of medication is presented as a particularly accessible option for the user. In this case the manufacturer of the medication may be a sponsor of the content. In this way, the manufacturer has the ability to directly market to users who could benefit from their product with a compelling customized video.

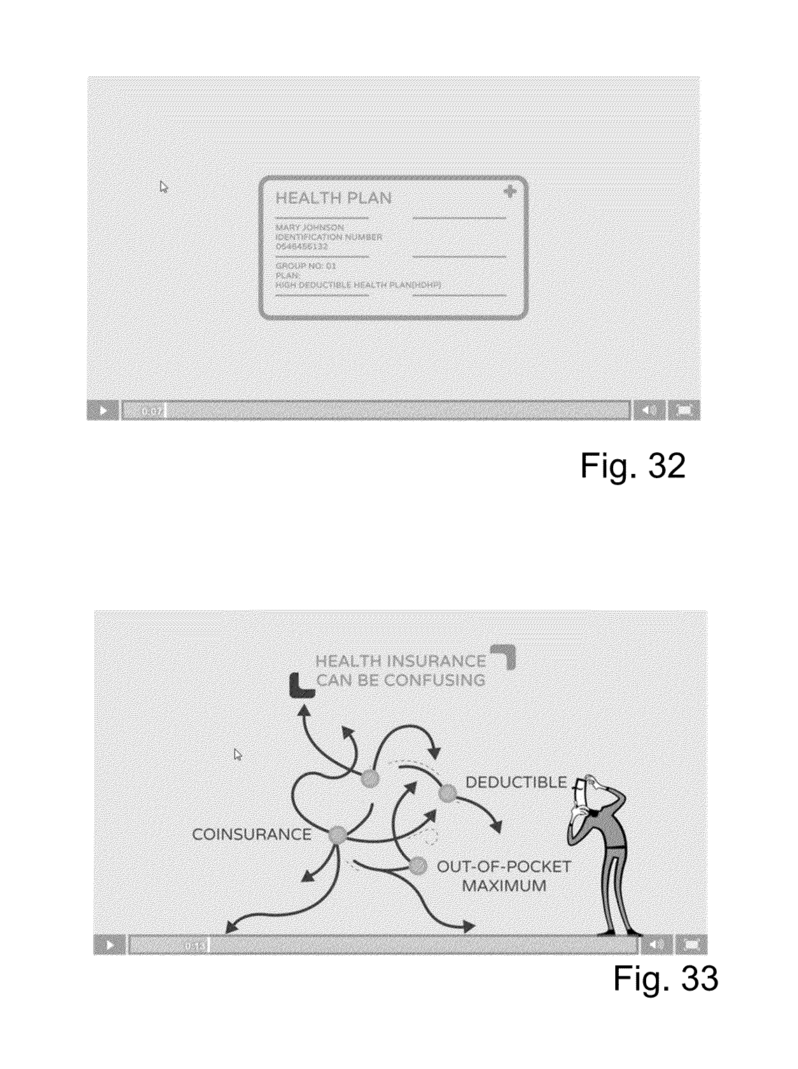

FIG. 32 presents yet another customized video for the education of the user on how health plans operate. Basic education regarding health plans allows users to make better decisions when shopping for health insurance. In FIG. 32, the health insurance card of the user is shown with accurate data or information for the user. Again, by showing the user their own data or information, they are more likely to remain engaged throughout the video.

In this video, common terms of a health insurance plan are explained, as seen in FIG. 33. Specifics of the user's health care spending and plan limits may be utilized in order to illustrate to the user the impact of how terms like ‘deductible’, ‘coinsurance’ and ‘out-of-pocket-maximum’ directly impact them, as seen in FIGS. 34, 35 and 36.

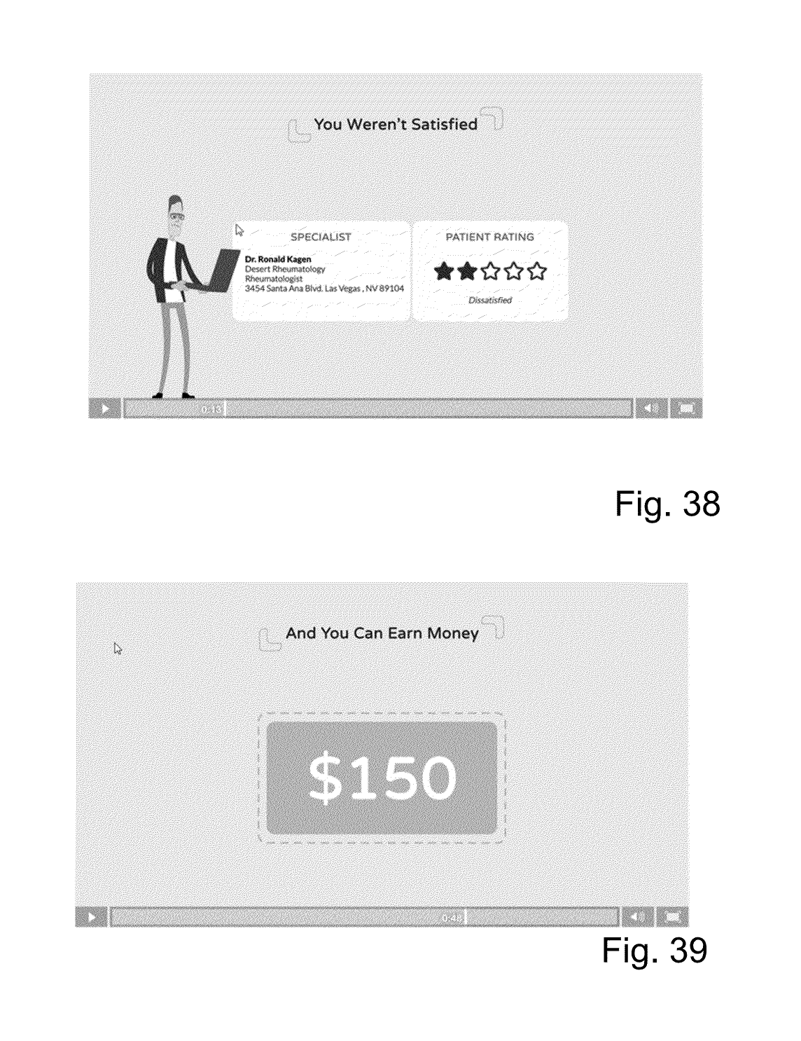

FIG. 37 provides a screenshot of yet another customized animation where the user is assisted in finding a new provider. The user's medical condition and the type of specialist needed to treat the condition are initially presented. Next, the animation shown the user their previously submitted satisfaction data, or other third-party satisfaction or quality data for the specialist they used previously, as seen at FIG. 38.

The advantages of such a program are numerous. For example, a different specialist could provide the user with a more satisfactory experience, have greater expertise, or provide a second opinion. A recommended specialist may be presented on a map that is geographically close to the user. Additional information, such as how to contact the referral service, and assurance that the ultimate choice is up to the user may also be conveyed. This is followed by an incentive, which may vary based upon providers in the area who partner with the search company, employer incentives, and insurance company rewards. Thus this reward value presented in FIG. 39 may also be customized based upon the user.

As previously noted, the above example screenshots are related to the particular field of healthcare education and administration. However, the presently disclosed media customization may be applicable to a number of fields, which are presented below along with example use cases.

### 1) Human Resources (HR)

Within the field of HR, HR teams provide employees with a variety of benefits and services, but may be unable to communicate these benefits in an engaging and effective manner. As a result, financial, health, and other benefits are under-utilized or not fully understood, and HR teams don't get full credit for their offerings and efforts. The disclosed media customization may be employed to generate animations that help inform employees (users) of their HR options in these situations.

The animations that are generated within this context can draw from a set of proprietary data sources that enable highly customized content at the individual user level. These data sources include health insurance companies/Administrative Service Organization (ASO) medical data, Pharmacy Benefit Manager (PBM) or other pharmacy data, and accumulated data related to where the employee and their families are against their deductible, coinsurance, and out-of-pocket maximums.

Within this HR context, it may be beneficial to generate customized media related to benefits plan explanations that help a user understand his/her particular plan and how much he/she has spent year-to-date (as shown in one of the above examples). Likewise, an animation that shows information about alternative health plan choices offered by their employer that are more appropriate for their care needs and could therefore save them money could be generated (for example, recommending a high-deductible plan to members who could save money by switching to that plan versus a traditional PPO, including their specific savings based on their previous plan selection and spend). Another example is an animation that shows users with specific chronic diseases information on how to better manage their diseases or how to access a second opinion services offered by their employer.

Another HR-related animation could show users with high use of emergency room services information on less expensive options such as urgent care centers or local onsite clinics at employee workplaces or nearby retail clinics (with specific information on the nearest location) or telemedicine services. Another example is an animation to patients with prescription medications showing them ways to save money on their medications based on specific drugs they are currently taking, for example by switching to a similar but less expensive medicine to treat the same condition (therapeutic alternatives), splitting pills or taking separate pills instead of a combination pill). Another example is an animation to users who use retail pharmacy often but can save money and increase convenience by filling their chronic prescriptions through a mail-order pharmacy, with specific amount saved.

An additional customized media could include an animation to users that use a lot of radiology or lab services showing information on lower-cost radiation and lab facilities near their specific address.

Another example is an animation that shows how an employee can maximize savings or contributions into a 401(k) or IRA plan. Likewise, an animation that shows information about life or disability insurance to employees who do or do not have spouses or children could be appropriately customized to assist the user in benefits elections. Another example is an animation to communicate pre-tax benefits for service like transportation assistance, child care assistance, etc. The user could be targeted based on individual-specific factors like location, dependents on their plan, etc. Yet another example of an AGaAgaHR benefits related media customization would be an animation with an interactive plan chooser tool that helps a member decide the best plan to be on within that employer, or which plan to join on a private or public health insurance exchange.

Clearly these examples are not exhaustive, and merely are provided by way of example of possible animations that may be customized and could be effective within the HR field.

### 2) Drugs, Devices and Diagnostics

Moving on, within the field of drugs, medical devices and diagnostics it may be desirable to market to patients, physicians, and other healthcare providers in such a way that the content is targeted to specific populations that would benefit most from the particular drug, medical device or diagnostic service.

The personalized content that is generated within this context of drugs, medical devices and diagnostics may draw from a set of proprietary data sources that include benefits administration eligibility data, Pharmacy Benefit Manager (PBM) or other pharmacy data, data from clinical studies and trials (e.g., radiation dose), PACS distributed system for sharing radiology data and images, Electronic Medical Records data, and medical claims data for diagnostic information.

Within the drugs, medical devices and diagnostics context, it may be beneficial to generate customized media related to providing alternative medications for a user based upon their other prescriptions. For example, a user who use an antihistamine pill without a nasal steroid may be encouraged to use nasal steroid in addition to the antihistamine. Another example is an animation to help device manufacturers communicate with medical providers the best way to use new or existing devices, based on the specific behaviors, specialty, and/or needs of that provider. For example, a radiologist or radiation technician may be presented a radiation dose video that incorporates the average radiation dose they deliver when doing a scan over a given time period, compared to other similar radiologists and technicians and industry-recognized benchmarks.

Another animation could help emphasize the importance of medication compliance and adherence based on the specific prescriptions and fill patterns of the individual. Likewise, the animations described above relating to prescription management and money savings opportunities disclosed above in relation to HR applications may be equally applicable to the drugs, medical devices and diagnostics context.

Like before, these examples are not exhaustive, and merely are provided by way of example of possible animations that may be customized and that could be effective within the drugs, medical devices and diagnostics field.

### 3) Advertising

Moving on, within the field of advertising, the ability to uniquely tailor the media to potential consumers has significant benefit. Particularly when advertising within the medical space, advertising firms may not be familiar with large, sensitive, regulated, and often messy data sets like medical and pharmacy claims data. They may not have access to, or know how to use, this data to target advertisements for employers, health plans, hospitals, medical providers, or patients. The disclosed media customization may solve many of these issues for advertisers.

The key to a successful advertisement using customized media is access to proprietary or specialized data relating to the target audience. Thus the data sources could include any of the above mentioned data sources, along with customer information provided by the company that is offering goods and services.

One such example, would be an advertising campaign for a provider of stem cell storage. Such companies provide long term storage for consumers of stem cells obtained from umbilical cord blood. These companies have large data sets associated with their consumers, including medical and demographic data. Animations could be generated that are directed toward loyal users of a stem cell storage company who have stored cord blood for multiple children to try to encourage them to refer their friends and family.

Of course, any company, not just in health care, with a sufficient data set relating to their consumers could utilize the media customization to better target their advertising campaigns.

Like before, these examples are not exhaustive, and merely are provided by way of example of possible animations that may be customized and that could be effective within the advertising field.

### 4) Financial Services

Moving on, within the field of financial services, it may be a major benefit to users to more fully understand their investments and savings activities. Like with the above examples, financial services firms typically have access to significant user specific data that may be employed to customize informational media. Within this field, the customized media may be used to educate employees or customers on their retirement vehicle options, explain tax implications of various savings methods, help them allocate their assets, or help them maximize the amount they save for retirement.

The animations that are generated within this financial services field may come from a set of data sources that include benefits administration eligibility data, investment account information, and any other available demographic data (age, race, salary, etc.).

Within the financial services context, it may be beneficial to generate customized media that shows an individual his/her current 401(k) or IRA balances and asset allocations, and allows the user to interact with the animation to see how changing the allocation is likely to change returns and risk.

A firm that manages investments could send an animation that shows the value of a Roth IRA and how it can fit with a person's specific investment portfolio (“you've invested a lot, but have not maxed out your Roth IRA”) and the person's demographic information (“As a 35-year old, investing in a Roth IRA can have a big impact on your overall savings due to many decades compound interest and tax deferral).

And as previously discussed, animations could be generated that show employees how to maximize 401(k) savings and that communicate pre-tax benefits for things like transportation assistance, child care assistance, etc. We could target based on individual-specific factors like location, dependents on their plan, etc.

Like before, these examples are not exhaustive, and merely are provided by way of example of possible animations that may be customized and that could be effective within the financial services field.

### 5) Improved Healthcare Outcomes

Within the field of healthcare, it may be beneficial to provide customized media that improves healthcare delivery and outcomes, typically through patient engagement post-discharge, and via outreach to practitioners. These needs are made particularly acute due to regulations from the HITECH Act and Affordable Care Act incentivizing providers to focus on outcome and increase patient education.

The data utilized for these customized animations is typically derived from electronic medical and pharmacy records data, medical and pharmacy claims data, and e-admission data from the provider/health system.

Within the healthcare context, it may be beneficial to generate customized media related to animations that help a patient get their post-discharge instructions following a surgery. And as previously discussed, animations could be generated that help emphasize the importance of pill compliance for the prescribed pills for a specific individual following a hospital discharge, or to help large medical study authors communicate with medical professionals the best way to use devices, such as the above discussed radiation dose video. This could include interactive features to allow user to select specific types of CT scans they are more curious about, for example.

Like before, these examples are not exhaustive, and merely are provided by way of example of possible animations that may be customized and that could be effective within the healthcare field.

### 6) Sales Services

Lastly, within the field of sales services, it may be beneficial to provide customized media that allows automated engaging ways to follow up with sales prospects. Additionally, customized media could be utilized to engage and educate sales people, especially when they are distributed geographically, or by business segments.

Sales- and services-related customized media can pull upon Customer Resource Management (CRM) tools and their associated data. The customized media may include animations that go to sales prospects, reminding them of the value proposition of the product. The animations may be driven using data from the CRM about that specific prospect and the specific product. Likewise, animations could be generated that go to sales teams or sales people to communicate how they're doing against sales goals and areas that may ripe for exploration based on CRM data.

Like before, these examples are not exhaustive, and merely are provided by way of example of possible animations that may be customized and that could be effective within the sales services field.

### IV. System Embodiments

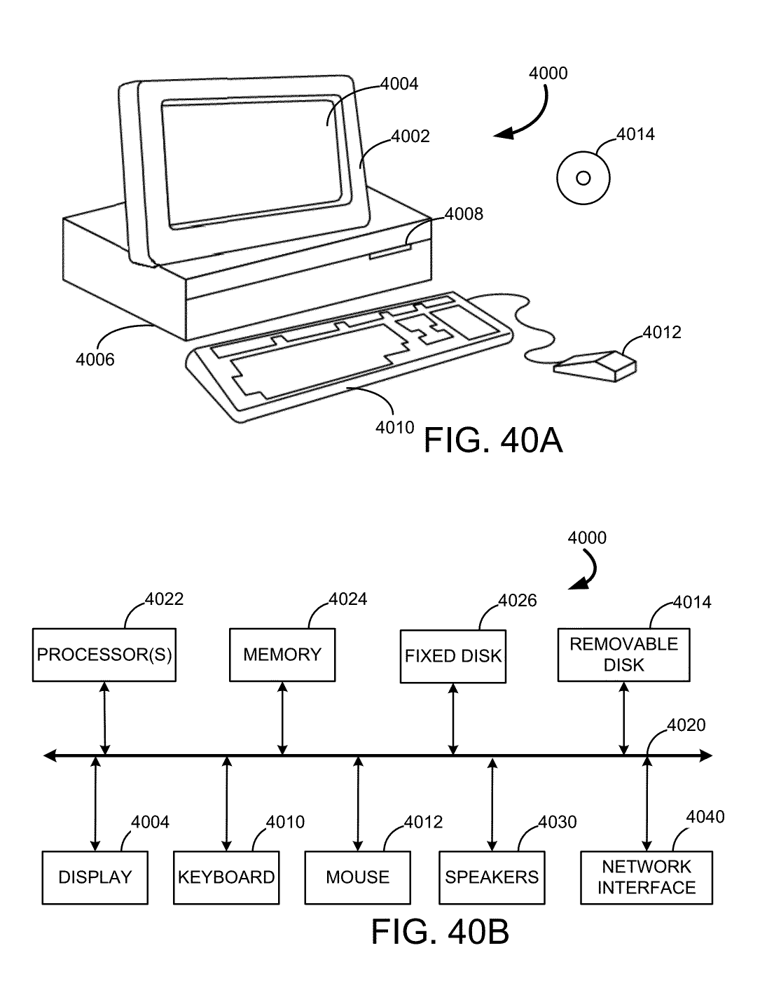

FIGS. 40A and 40B illustrate a Computer System 4000, which is suitable for implementing embodiments of the present invention. FIG. 40A shows one possible physical form of the Computer System 4000. Of course, the Computer System 4000 may have many physical forms ranging from a printed circuit board, an integrated circuit, or a small handheld device up to a huge super computer. Computer system 4000 may include a Monitor 4002, a Display 4004, a Housing 4006, a Disk Drive 4008, a Keyboard 4010, and a Mouse 4012. Disk 4014 is a computer-readable medium used to transfer data to and from Computer System 4000.

FIG. 40B is an example of a block diagram for Computer System 4000. Attached to System Bus 4020 are a wide variety of subsystems. Processor(s) 4022 (also referred to as central processing units, or CPUs) are coupled to storage devices, including Memory 4024. Memory 4024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Disk 4026 may also be coupled bi-directionally to the Processor 4022; it provides additional data storage capacity and may also include any of the computer-readable media described below. Fixed Disk 4026 may be used to store programs, data, and the like and is typically a secondary storage medium (such as a hard disk) that is slower than primary storage. It will be appreciated that the information retained within Fixed Disk 4026 may, in appropriate cases, be incorporated in standard fashion as virtual memory in Memory 4024. Removable Disk 4014 may take the form of any of the computer-readable media described below.

Processor 4022 is also coupled to a variety of input/output devices, such as Display 4004, Keyboard 4010, Mouse 4012 and Speakers 4030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 4022 optionally may be coupled to another computer or telecommunications network using Network Interface 4040. With such a Network Interface 4040, it is contemplated that the Processor 4022 might receive information from the network, or might output information to the network in the course of performing the above-described customized media generation and presentation. Furthermore, method embodiments of the present invention may execute solely upon Processor 4022 or may execute over a network such as the Internet in conjunction with a remote CPU that shares a portion of the processing.

In sum, the present invention provides a system and methods for media customization and presentation. The advantages of such a system include the ability to provide users with more relevant information, thereby increasing user engagement and understanding. Such systems may have particular utility for advertising, education, and in the healthcare, financial services, and marketing field.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for providing customized media for human resource management comprising:
pre-populating human resource-related data for at least one user, the data from at least one of an insurance company; a pharmacy benefit manager, a dental insurance plan, a vision plan, a benefits administration and enrollment/eligibility database; a Human Resources Information System (HRIS) database, a database with information on employer-sponsored accounts, a health risk assessment database, a biometrics database, an electronic medical record database, a non-electronic medical record database; a database of medical and Rx services searched by the user on a separate web application, a database of medical provider ratings, a database that uses 270/271 transactions to determine accumulated health spend, and a database of investment amounts, allocations, and limits for employer-sponsored savings programs;
generating customized media for each of the at least one user using the data, wherein the customized media includes data specific to the user incorporated within the animation; and
presenting the generated customized media to at least one user.

2. The method of claim 1, wherein the customized media is at least one animation or live-action video.

3. The method of claim 1, wherein the video is rendered utilizing action scripts and vector inputs.

4. The method of claim 1, wherein the customized media explains or provides education or information on particular benefits plan selections of the user, wherein the particular benefits plan selections are part of the benefits administration and enrollment database, or are part of a list of one or more external plan selections by users.

5. The method of claim 1, wherein the customized media shows information about alternative health plan choices offered to the user that may be most appropriate for the user's care needs based upon previous plan selections contained within the benefits administration and enrollment database and data within the insurance claims and spend databases.

6. The method of claim 1, wherein the customized media shows the user with one or more specific diseases or conditions information on how to better manage at least one of the diseases or conditions, how to access a second opinion service offered by the user's company, and how to access other resources offered by the user's company to assist with better care.

7. The method of claim 1, wherein the customized media shows users with high use of emergency room services information on less expensive options.

8. The method of claim 1, wherein the customized media shows the user at least one of less expensive medication options including therapeutic substitution, pill splitting, or combination pills, revised medication dosing, and alternative medication fulfillment options, based upon the users current prescription, pharmacy claims, and fulfillment information.

9. The method of claim 1, wherein the customized media shows users who have received treatments, medication, laboratory tests, imaging studies, office visits, surgery, or other procedures information on lower cost sources of said services near the user's address.

10. The method of claim 1, wherein the customized media shows users how to maximize savings or employer matching within a retirement vehicle in comparison to current retirement savings elections and allocations.

11. The method of claim 1, wherein the customized media shows users information regarding benefits for transportation assistance, child care assistance, and medical savings plans.

12. The method of claim 1, wherein the customized media shows users information about regular health, wellness, or disease prevention actions the user can take, based on age, sex, and medical history of the user.

13. The method of claim 1, wherein the customized media shows users information about their own past health care choices with personalized percentage of expensive and inexpensive providers and savings associated with changes in past choices.

14. The method of claim 1, where in the customized media shows users information about other types of mandatory or voluntary insurance options offered through the employer, including disability insurance, life insurance, vision insurance, dental insurance, or long-term care insurance, based on information about at least one of users' family, age, dependents, marital status, and medical and pharmacy history.

15. An animated media customization system for providing customized media for human resource management comprising:
a database configured to pre-populate benefits-related data for at least one user, at least one of an insurance company, a pharmacy benefit manager, a dental insurance plan, a vision plan, benefits administration and enrollment/eligibility, a Human Resources Information System (HRIS), information on employer-sponsored accounts, health risk assessment data, biometrics data, electronic medical records, non-electronic medical records, information on medical and Rx services searched by the user on a separate web application, medical provider ratings, 270/271 transactions to determine accumulated health spend, and investment amounts, allocations, and limits for employer-sponsored savings programs;
a rendering engine configured to generate customized media for each of the at least one user using the acquired data, wherein the customized media includes data specific to the user incorporated within the media; and
an interface configured to present the generated customized media to the at least one user.

16. The system of claim 15, wherein the customized media is at least one animation or other live-action video.

17. The system of claim 15, wherein the rendering engine renders the media utilizing action scripts and vector inputs.

18. The system of claim 15, wherein the customized media explains or provides education or information on particular benefits plan selections of the user, wherein the particular benefits plan selections are part of the benefits administration and enrollment database, or are part of a list of one or more external plan selections by users.

19. The system of claim 15, wherein the customized media shows information about alternative health plan choices offered to the user that are most appropriate for the user's care needs based upon previous plan selections, and insurance claims and spend data.

20. The system of claim 15, wherein the customized animated media shows user with specific diseases or conditions information on how to better manage at least one of the diseases or conditions, how to access a second opinion services offered by the user's company, and how to access other resources offered by the user's company to assist with better care.

21. The system of claim 15, wherein the customized animated media shows users with high use of emergency room services, information on less expensive options.

22. The system of claim 15, wherein the customized animated media shows the user at least one of less expensive medication options including therapeutic substitution, pill splitting, or combination pills, revised medication dosing, and medication fulfillment options, based upon the users current prescription, pharmacy claims, and fulfillment information.

23. The system of claim 15, wherein the customized animated media shows users who have received treatments, medication, laboratory tests, imaging studies, office visits, or surgery information on lower cost sources of said services near the user's address.

24. The system of claim 15, wherein the customized animated media shows users how to maximize savings or employer matching within a retirement vehicle in comparison to current retirement savings elections and allocations.

25. The system of claim 15, wherein the customized animated media shows users information regarding benefits for transportation assistance, child care assistance, and medical savings plans.

26. The method of claim 15, wherein the customized media shows users information about regular health, wellness, or disease prevention actions the user can take, based on age, sex, and medical history of the user.

27. The method of claim 15, wherein the customized media shows users information about their own past health care choices with personalized percentage of expensive and inexpensive providers and specific dollar savings associated with changes in past choices.

28. The method of claim 15, where in the customized media shows users information about other types insurance options offered through the employer, including disability insurance, life insurance, disability insurance, vision, insurance, dental insurance, and long-term care insurance, based on information about users family, age, dependents, marital status, medical and pharmacy history.
